(19) United States
(12) Patent Application Publication
(10) Pub. No.: US 2020/0071500 A1
(43) Pub. Date: Mar. 5, 2020

(54) RESIN COMPOSITION AND RESIN MOLDED ARTICLE

(71) Applicant: FUJI XEROX CO., LTD., Tokyo (JP)

(72) Inventors: Kenji YAO, Minamiashigara-shi (JP); Kana MIYAZAKI, Minamiashigara-shi (JP); Ryo TANAKA, Minamiashigara-shi (JP)

(73) Assignee: FUJI XEROX CO., LTD., Tokyo (JP)

(21) Appl. No.: 16/263,315

(22) Filed: Jan. 31, 2019

(30) Foreign Application Priority Data
Aug. 31, 2018 (JP) 2018-164060

(51) Int. Cl. C08L 1/14; C08K 3/08; C08K 5/101; C08K 5/11; C08K 5/00; C08K 5/13; C08L 33/10; B29C 45/00

(52) U.S. Cl. CPC C08L 1/14; C08K 3/08; C08K 5/101; C08K 5/11; C08K 5/0016; C08K 5/13; B29K 2001/14; B29C 45/0001; C08K 2003/0856; C08K 2003/0862; C08L 2207/04; C08L 2207/53; C08L 33/10

(57) ABSTRACT

A resin composition includes a resin having a biomass-derived carbon atom and satisfies at least one of the following conditions (1) to (3), (1) a content of an iron element in the resin composition is from 0.1 ppm to 5 ppm with respect to the resin composition, (2) a content of a nickel element in the resin composition is from 0.05 ppm to 2 ppm with respect to the resin composition, and (3) a content of a chromium element in the resin composition is from 0.05 ppm to 3 ppm with respect to the resin composition.

### CROSS-REFERENCE TO RELATED APPLICATIONS

This application is based on and claims a priority under 35 USC 119 from Japanese Patent Application No. 2018-164060 filed on Aug. 31, 2018.

### BACKGROUND

### Technical Field

The present invention relates to a resin composition and a resin molded article.

### Related Art

In the related art, various resin compositions have been provided and used for various purposes. The resin compositions have been particularly used for household electric appliances and various parts of automobiles, housings, and the like. In addition, thermoplastic resins have been also used for parts such as office equipment and housings of electronic and electrical equipment.

In recent years, a resin derived from biomass (organic resources derived from organisms except a fossil resource) has been used, and as one of resins having a biomass-derived carbon atom known in the related art, cellulose acylate may be exemplified.

As the resin composition in the related art, the following compositions disclosed in JP-A-2013-079319, JP-A-10-101925 and JP-T-2015-504111 may be exemplified.

JP-A-2013-079319 discloses a resin composition containing (A) cellulose ester, (B) styrene-based resin, and (C) titanium dioxide, in which in a content of each of (A) component and (B) component, the (A) component is 50% to 95% by weight, and the (B) component is 5% to 50% by weight, and a content of (C) component is 0.1 to 10 parts by mass with respect to a total content (100 parts by mass) of the (A) component and the (B) component, and the resin composition does not contain a compatibilizer of the (A) component and the (B) component.

JP-A-10-101925 discloses a resin composition for a sliding member containing a complex metal oxide of 0.1% to 3% by weight; calcium fluoride of 0.5% to 8% by weight, and tungsten disulfide of 0.5% to 8% by weight, and the balance of nylon 11 or nylon 12.

JP-T-2015-504111 discloses a composition containing lignin; an element less than about 2000 mg in total per 1 kg of the lignin, in which the element is Al, As, B, Ba, Be, Ca, Cd, Co, Cr, Cu, Fe, K, Li, Mg, Mn, Mo, Na, Ni, P, Pb, S, Sb, Se, Si, Sn, Sr, Ti, Tl, V, and Zn.

### SUMMARY

Aspects of certain non-limiting embodiments of the present disclosure relate to a resin composition capable of obtaining a resin molded article excellent in chemical resistance, in a resin composition containing a resin having a biomass-derived carbon atom.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a resin composition containing a resin having a biomass-derived carbon atom and satisfying at least one of the following conditions (1) to (3).

(1) A content of an iron element in the resin composition is from 0.1 ppm to 5 ppm with respect to the resin composition.

(2) A content of a nickel element in the resin composition is from 0.05 ppm to 2 ppm with respect to the resin composition.

(3) A content of a chromium element in the resin composition is from 0.05 ppm to 3 ppm with respect to the resin composition.

### DETAILED DESCRIPTION

Hereinafter, an exemplary embodiment which is an example of the present invention will be described. These descriptions and examples are illustrative of the exemplary embodiments and do not limit the scope of the exemplary embodiments. In numerical value ranges stated in a stepwise manner, the upper limit value or the lower limit value described in one numerical value range may be replaced with the upper limit value or the lower limit value of the other numerical value range described in a stepwise manner. In addition, in the numerical value range described in this exemplary embodiment, the upper limit value or the lower limit value of the numerical value range may be replaced with values described in examples. In the exemplary embodiment, the term “step” includes not only an independent step but also a case where the intended purpose of the step may be achieved even if it may not be clearly distinguished from other steps. In the exemplary embodiment, each component may contain plural kinds of corresponding substances. In the exemplary embodiment, in a case of referring to the amount of each component in the composition, if there are plural kinds of substances corresponding to each component in the composition, unless otherwise specified, it means the total amount of the plural kinds of substances. In the exemplary embodiment, “(meth)acryl” means at least one of acryl and methacryl, and “(meth)acrylate” means at least one of acrylate and methacrylate. In the exemplary embodiment, cellulose acylate (A), ester compound (B), plasticizer (C), and thermoplastic elastomer (D) are also referred to as component (A), component (B), component (C), and component (D), respectively.

<Resin Composition>

The resin composition according to the exemplary embodiment contains a resin having a biomass-derived carbon atom and satisfies at least one of the following conditions (1) to (3). (1) a content of an iron element in the resin composition is from 0.1 ppm to 5 ppm with respect to the resin composition. (2) a content of a nickel element in the resin composition is from 0.05 ppm to 2 ppm with respect to the resin composition. (3) a content of a chromium element in the resin composition from 0.05 ppm to 3 ppm with respect to the resin composition.

The resin composition according to the exemplary embodiment may contain other components such as ester compound (B), plasticizer (C), and thermoplastic elastomer (D) described later.

Unlike a resin composition derived from a fossil resource such as petroleum, it is hard to design a molecular structure freely in a resin composition containing a biomass-derived component in the related art, and is difficult to impart desired properties.

In addition, many resins having biomass-derived carbon atoms have excellent chemical resistance, as typified by cellulose acylate and polyamide 11. It may be said that it is a natural ability to respond to changes in the surrounding environment. However, with respect to chemicals such as hand cream and sunscreen which have a large influence on a resin, the chemical resistance of the obtained resin molded article is not sufficient even with cellulose acylate or polyamide 11, and cracks and crazes occur in some cases.

In contrast, the resin composition according to the exemplary embodiment contains a resin having a biomass-derived carbon atom, and satisfies at least one of the above conditions (1) to (3) so as to obtain a resin molded article excellent in the chemical resistance. The reason for this is inferred as follows.

As one of the chemicals having a large influence on a resin, a vegetable oil may be exemplified. The present inventors think that such a chemical acts on a resin component of a resin composition, the resin decomposes, the strength of the resin composition is decreased, and thereby breakage such as cracks occurs in the resin molded article. When the resin composition contains a resin having a biomass-derived carbon atom, the resin composition has high affinity for chemicals as compared with a petroleum-derived resin, and thus has relatively high chemical resistance. Even with the high chemical resistance, destruction of the resin molded article may still occur in some cases.

On the other hand, it is presumed that when traces of a specific type of metal element are present in the resin composition, a structure such as a core-shell containing the metal element as a nucleus, which the chemical such as a vegetable oil does not permeate, is formed in the resin composition, and penetration and influence on the resin molded article due to the contact of the chemical is prevented. Regarding the kinds and amount of the metal elements, in a case where the resin composition contains an iron element of from 0.1 ppm to 5 ppm, a nickel element of from 0.05 ppm to 2 ppm, or a chromium element of from 0.05 ppm to 3 ppm, due to a polarity relationship with the resin having a biomass-derived carbon atom, dispersion uniformity of the metal element is excellent, the core-shell structure works functionally, and the influence by the chemical is prevented, thereby improving the chemical resistance.

From the above reasons, it is considered that the resin molded article obtained from the resin composition in the exemplary embodiment is excellent in the chemical resistance.

Hereinafter, the components of the resin composition according to the exemplary embodiment will be described in detail.

<Content of Metal Element>

The resin composition according to the exemplary embodiment satisfies at least one of the following conditions (1) to (3). (1) a content of an iron element in resin composition is from 0.1 ppm to 5 ppm with respect to the resin composition. (2) a content of a nickel element in resin composition is from 0.05 ppm to 2 ppm with respect to the resin composition. (3) a content of a chromium element in resin composition is from 0.05 ppm to 3 ppm with respect to the resin composition.

In addition, from the viewpoint of the chemical resistance of the obtained resin molded article, the resin composition according to the exemplary embodiment preferably satisfies at least two of the above conditions (1) to (3), and is more preferably the above conditions (1), (2), and (3).

In the exemplary embodiment, a method of measuring the content of each of the metal elements in the resin composition is performed to measure the content of at least one of the metal element selected from the group consisting of an iron element, a nickel element, and a chromium element with respect to the entire resin composition by using a high resolution inductively coupled plasma (ICP) emission spectroscopic analyzer (PS 3500 DDII manufactured by Hitachi High-Tech Sciences Co., Ltd.).

From the viewpoint of the chemical resistance of the obtained resin molded article, the resin composition according to the exemplary embodiment satisfies at least the above condition (1), that is, preferably contains from 0.1 ppm to 5 ppm of iron element with respect to the resin composition, more preferably contains from 0.3 ppm to 4.5 ppm of iron element with respect to the resin composition, still more preferably contains from 1.0 ppm to 4.0 ppm of iron element with respect to the resin composition, and particularly preferably contains from 2.0 ppm to 3.5 ppm of iron element with respect to the resin composition.

From the viewpoint of the chemical resistance of the obtained resin molded article, the resin composition according to the exemplary embodiment satisfies at least the above condition (2), that is, preferably contains from 0.05 ppm to 2 ppm of nickel element with respect to the resin composition, more preferably contains from 0.1 ppm to 1.6 ppm of nickel element with respect to the resin composition, still more preferably contains from 0.5 ppm to 1.5 ppm of nickel element with respect to the resin composition, and particularly preferably contains from 1.0 ppm to 1.5 ppm of nickel element with respect to the resin composition.

From the viewpoint of the chemical resistance of the obtained resin molded article, the resin composition according to the exemplary embodiment satisfies at least the above condition (3), that is, preferably contains from 0.05 ppm to 3 ppm of chromium element with respect to the resin composition, more preferably contains from 0.1 ppm to 2.7 ppm of chromium element with respect to the resin composition, still more preferably contains from 1.0 ppm to 2.5 ppm of chromium element with respect to the resin composition, and particularly preferably contains from 1.5 ppm to 2.3 ppm of chromium element with respect to the resin composition.

The resin composition according to the exemplary embodiment contains an iron element, a nickel element, and a chromium element in a state of a metal simple substance, in a state of a metal salt, or in a state of a metal complex; however, from the viewpoint of dispersibility, temporal stability, and chemical resistance of the obtained resin molded article, it is preferable to be contained in the state of the metal simple substance (zero valent metal).

In addition, from the viewpoint of the dispersibility, the temporal stability, and the chemical resistance of the obtained resin molded article, the resin composition according to the exemplary embodiment preferably contains particles containing at least one selected from the group consisting of an iron element, a nickel element, and a chromium element, more preferably contains at least one selected from the group consisting of iron particles, nickel particles, and chromium particles, still more preferably contains at least two selected from the group consisting of the iron particles, the nickel particles, and the chromium particles, and particularly preferably contains the iron particles, the nickel particles, and the chromium particles. All of the iron particle, the nickel particle, and the chromium particle may contain other trace elements (for example, less than 1% by mass with respect to the total mass of the particles).

A volume average particle diameter of the particles is preferably from 10 nm to 200 μm, and is more preferably from 10 nm to 100 μm.

In a method of measuring the volume average particle diameter of the particles, a section of the resin composition or the resin molded article is observed with an electron microscope, and an equivalent circle diameter thereof is measured so as to calculate the volume average particle diameter.

[Resin Having Biomass-Derived Carbon Atom]

The resin composition according to the exemplary embodiment contains a resin having a biomass-derived carbon atom.

The resin having a biomass-derived carbon atom is not particularly limited, and a known resin having a biomass-derived carbon atom has been used.

In addition, as the resin having a biomass-derived carbon atom, all resins need not necessarily be derived from biomass, and at least a part thereof may have a structure derived from biomass. Specifically, for example, cellulose acylate described below may have a cellulose structure derived from biomass and an acylate structure derived from petroleum.

Note that, “resin having a biomass-derived carbon atom” in the exemplary embodiment is a resin having at least carbon atoms derived from organic resources derived from organisms excluding fossil resources, and as described below, based on the regulation of ASTM D 6866:2012, the presence of the biomass-derived carbon atoms is indicated from the abundance of ¹⁴C.

From the viewpoint of the chemical resistance in the obtained resin molded article, the content defined in ASTM D6866:2012 of the biomass-derived carbon atom in the resin composition according to the exemplary embodiment is preferably 20% or more, is more preferably 30% or more, is still more preferably is 35% or more, and is particularly preferably 40% to 100%, with respect to a total amount of carbon atoms in the resin composition.

In addition, in the exemplary embodiment, the method of measuring the content of the biomass-derived carbon atom of the resin composition is to calculate the content of the biomass-derived carbon atom by measuring the abundance of ¹⁴C in the total carbon atoms in the resin composition based on the regulation of ASTM D 6866:2012.

Examples of the resin having a biomass-derived carbon atom include cellulose acylate, polylactic acid, biomass-derived polyolefin, biomass-derived polyethylene terephthalate, biomass-derived polyamide, poly (3-hydroxybutyric acid), polytrimethylene terephthalate (PTT), polybutylene succinate (PBS), phosphatidylglycerol (PG), an isosorbide polymer, and an acrylic acid modified rosin.

Among them, from the viewpoint of the chemical resistance in the obtained resin molded article, the resin having a biomass-derived carbon atom preferably contains cellulose acylate (A), and more preferably the resin having a biomass-derived carbon atom is cellulose acylate (A).

—Cellulose Acylate (A): Component (A)—

Cellulose acylate (A) is a cellulose derivative in which at least part of the hydroxy group in cellulose is substituted (acylated) with an acyl group. The acyl group is a group having a structure of —CO—R^{AC} (R^{AC} represents a hydrogen atom or a hydrocarbon group).

Cellulose acylate (A) is cellulose derivative represented by Formula (CA).

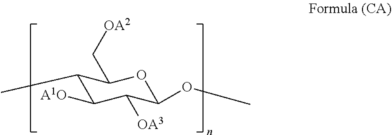

In Formula (CA), A¹, A², and A³ independently represent a hydrogen atom or an acyl group, and n represents an integer of 2 or more. Here, at least a part of n A¹, n A², and n A³ represents an acyl group. All of n A¹ in the molecule may be the same, partly the same, or different from each other. Similarly, all n A² in the molecule may be the same, partly the same, or different from each other and all n A³ in the molecule may be the same, partly the same, or different from each other.

In an acyl group represented by A¹, A², and A³, a hydrocarbon group in the acyl group may be linear, branched, or cyclic, but it is preferably linear or branched, and is more preferably linear.

In an acyl group represented by A¹, A², and A³, a hydrocarbon group in the acyl group may be a saturated hydrocarbon group or may be an unsaturated hydrocarbon group, and is more preferably saturated hydrocarbon group.

An acyl group represented by A¹, A², and A³ is preferably an acyl group having 1 to 6 carbon atoms. That is, as cellulose acylate (A), cellulose acylate (A) having an acyl group with 1 to 6 carbon atoms is preferable. With cellulose acylate (A) having an acyl group with 1 to 6 carbon atoms, it is easy to obtain a resin molded article more excellent in the chemical resistance as compared with a case of cellulose acylate (A) having an acyl group having 7 or more carbon atoms.

An acyl group represented by A¹, A², and A³ may be a group in which a hydrogen atom in the acyl group is substituted with a halogen atom (for example, a fluorine atom, a bromine atom, and an iodine atom), an oxygen atom, a nitrogen atom or the like, and is preferably an unsubstituted group.

Examples of acyl group represented by A¹, A², and A³ include a formyl group, an acetyl group, a propionyl group, a butyryl group (a butanoyl group), a propenoyl group, and a hexanoyl group. Among them, from the viewpoint of the formability of the resin composition and the chemical resistance of the resin molded article, the acyl group is more preferably an acyl group having 2 to 4 carbon atoms, and is still more preferably an acyl group having 2 or 3 carbon atoms.

Examples of cellulose acylate (A) include cellulose acetate (cellulose monoacetate, cellulose diacetate (DAC), and cellulose triacetate), cellulose acetate propionate (CAP), and cellulose acetate butyrate (CAB).

From the viewpoint of the chemical resistance in the obtained resin molded article, cellulose acylate (A) is preferably cellulose acetate propionate (CAP) and cellulose acetate butyrate (CAB), and is more preferably cellulose acetate propionate (CAP).

Cellulose acylate (A) may be used alone or two or more kinds thereof may be used in combination.

A weight average degree of polymerization of cellulose acylate (A) is preferably 200 to 1000, and is more preferably 600 to 1000 from the viewpoint of the formability of the resin composition and the chemical resistance in the obtained resin molded article.

The weight average degree of polymerization of cellulose acylate (A) is determined from the weight average molecular weight (Mw) by the following procedure.

First, the weight average molecular weight (Mw) of cellulose acylate (A) is measured in terms of polystyrene by using tetrahydrofuran with gel permeation chromatography apparatus (GPC apparatus: manufactured by TOSOH CORPORATION, HLC-8320GPC, column: TSKgelα-M).

Next, the weight average molecular weight (Mw) of cellulose acylate (A) is divided by a molecular weight of a constituent unit of cellulose acylate (A) to determine the polymerization degree of cellulose acylate (A). For example, in a case where a substituent of the cellulose acylate is an acetyl group, the molecular weight of the constituent unit is 263 when a degree of substitution is 2.4 and 284 when the degree of substitution is 2.9.

The weight average molecular weight (Mw) of the resin in the exemplary embodiment is also measured by the same method as the method of measuring the weight average molecular weight of cellulose acylate (A).

From the viewpoint of the formability of the resin composition and the chemical resistance of the resin molded article to be obtained, the degree of substitution of cellulose acylate (A) is preferably from 2.1 to 2.9, is more preferably from 2.2 to 2.9, is still more preferably from 2.3 to 2.9, and is particularly preferably from 2.6 to 2.9.

In the cellulose acetate propionate (CAP), from the viewpoint of the formability of the resin composition and the chemical resistance of the resin molded article to be obtained, a ratio of the degree of substitution (acetyl group/propionyl group) of an acetyl group to a propionyl group is preferably from 0.01 to 1, and is more preferably from 0.05 to 0.1.

As CAP, CAP satisfying at least one of the following (1), (2), (3), and (4) is preferable, and CAP satisfying the following (1), (3), and (4) is more preferable, and CAP satisfying the following (2), (3), and (4) is still more preferable. (1) When measurement is performed by a GPC method with tetrahydrofuran as a solvent, a weight average molecular weight (Mw) in terms of polystyrene is 160000 to 250000, and a ratio Mn/Mz of number average molecular weight (Mn) in terms of polystyrene to Z-average molecular weight (Mz) in terms of polystyrene is from 0.14 to 0.21. (2) When measurement is performed by a GPC method with tetrahydrofuran as a solvent, a weight average molecular weight (Mw) in terms of polystyrene is 160000 to 250000, a ratio Mn/Mz of number average molecular weight (Mn) in terms of polystyrene to Z-average molecular weight (Mz) in terms of polystyrene is 0.14 to 0.21, and a ratio Mw/Mz of a weight average molecular weight (Mw) in terms of polystyrene to Z-average molecular weight (Mz) in terms of polystyrene is from 0.3 to 0.7. (3) When measurement is performed with capillograph at 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is from 0.1 to 0.3. (4) When a small square plate test piece (D11 test piece specified by JIS K7139:2009, 60 mm×60 mm, thickness of 1 mm) obtained by injection molding of CAP is left for 48 hours in an atmosphere at a temperature of 65° C. and a relative humidity of 85%, both an expansion coefficient in a MD direction and an expansion coefficient in a TD direction are 0.4% to 0.6%.

Here, the MD direction means a length direction of a cavity of a mold used for injection molding, and the TD direction means a direction orthogonal to the MD direction.

In the cellulose acetate butyrate (CAB), from the viewpoint of the formability of the resin composition and the chemical resistance of the resin molded article to be obtained, a ratio of the degree of substitution (acetyl group/butyryl group) of an acetyl group to a butyryl group is preferably from 0.05 to 3.5, and is more preferably from 0.5 to 3.0.

The degree of substitution of cellulose acylate (A) is an index indicating a degree to which the hydroxy group of cellulose is substituted by an acyl group. In other words, the degree of substitution is an index indicating a degree of acylation of cellulose acylate (A). Specifically, the degree of substitution means an intramolecular average of the number of substitutions in which three hydroxy groups in the D-glucopyranose unit of cellulose acylate are substituted with an acyl group. The degree of substitution is determined from a ratio of a peak integral of a cellulose-derived hydrogen atom to a peak integral of an acyl group-derived hydrogen atom with ¹H-NMR (JMN-ECA, prepared by JEOL RESONANCE).

The resin having a biomass-derived carbon atom may be used alone, or two or more kinds thereof may be used in combination.

[Ester Compound (B): Component (B)]

From the viewpoint of the chemical resistance in the obtained resin molded article, the resin composition according to the exemplary embodiment preferably further contains at least one ester compound (B) selected from the group consisting of a compound represented by Formula (1), a compound represented by Formula (2), a compound represented by Formula (3), a compound represented by Formula (4), and a compound represented by Formula (5).

Among them, from the viewpoint of the chemical resistance in the obtained resin molded article, as ester compound (B), the resin composition according to the exemplary embodiment more preferably contains at least one selected from the group consisting of the compound represented by Formula (1), the compound represented by Formula (2), and the compound represented by Formula (3), still more preferably contains at least one selected from the group consisting of the compound represented by Formula (1) and the compound represented by Formula (2), and particularly preferably contains the compound represented by Formula (1).

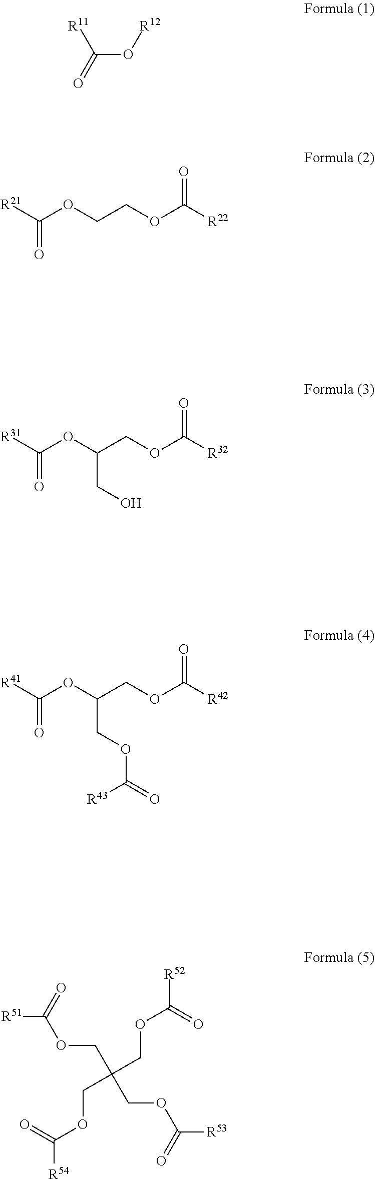

In Formula (1), R¹¹ represents an aliphatic hydrocarbon group having 7 to 28 carbon atoms and R¹² represents an aliphatic hydrocarbon group having 9 to 28 carbon atoms.

In Formula (2), R²¹ and R²² each independently represent an aliphatic hydrocarbon group having 7 to 28 carbon atoms.

In Formula (3), R³¹ and R³² each independently represent an aliphatic hydrocarbon group having 7 to 28 carbon atoms.

In Formula (4), R⁴¹, R⁴², and R⁴³ each independently represent an aliphatic hydrocarbon group having 7 to 28 carbon atoms.

In Formula (5), R⁵¹, R⁵², R⁵³ and R⁵⁴ each independently represent an aliphatic hydrocarbon group having 7 to 28 carbon atoms.

R¹¹ represents an aliphatic hydrocarbon group having 7 to 28 carbon atoms. From the viewpoint that the group represented by R¹¹ is likely to act as a lubricant with respect to the molecular chain of the resin, the group represented by R¹¹ is preferably an aliphatic hydrocarbon group having 9 carbon atoms or more, is more preferably an aliphatic hydrocarbon group having 10 carbon atoms or more, and is still more preferably an aliphatic hydrocarbon group having 15 carbon atoms or more. From the viewpoint that the group represented by R¹¹ is likely to enter between the molecular chains of the resin (particularly, cellulose acylate (A), the same applies hereinafter), the group represented by R¹¹ is preferably an aliphatic hydrocarbon group having 24 carbon atoms or less, is more preferably an aliphatic hydrocarbon group having 20 carbon atoms or less, and is still more preferably an aliphatic hydrocarbon group having 18 carbon atoms or less. The group represented by R¹¹ is particularly preferably an aliphatic hydrocarbon group having 17 carbon atoms.

The group represented by R¹¹ may be a saturated aliphatic hydrocarbon group, and an unsaturated aliphatic hydrocarbon group. From the viewpoint that the group represented by R¹¹ is likely to enter between the molecular chains of the resin, the group represented by R¹¹ is preferably a saturated aliphatic hydrocarbon group.

The group represented by R¹¹ may be a linear aliphatic hydrocarbon group, a branched aliphatic hydrocarbon group, or an aliphatic hydrocarbon group containing an alicyclic ring. From the viewpoint that the group represented by R¹¹ is likely to enter between the molecular chains of the resin, the group represented by R¹¹ is preferably an aliphatic hydrocarbon group not containing an alicyclic group (that is, a chain aliphatic hydrocarbon group), and is more preferably a linear aliphatic hydrocarbon group.

In a case where the group represented by R¹¹ is an unsaturated aliphatic hydrocarbon group, from the viewpoint that the group represented by R¹¹ is likely to enter between the molecular chains of the resin, the number of unsaturated bonds in the group represented by R¹¹ is preferably 1 to 3, is more preferably 1 or 2, and is still more preferably 1.

In a case where the group represented by R¹¹ is an unsaturated aliphatic hydrocarbon group, from the viewpoint that the group represented by R¹¹ is likely to enter between the molecular chains of the resin and easily acts as a lubricant with respect to the molecular chain of the resin, the group represented by R¹¹ preferably contains a linear saturated hydrocarbon chain having 5 to 24 carbon atoms, more preferably contains a linear saturated hydrocarbon chain having 7 to 22 carbon atoms, and still more preferably contains a linear saturated hydrocarbon chain having 9 to 20 carbon atoms, and particularly preferably contains a linear saturated hydrocarbon chain having 15 to 18 carbon atoms.

In a case where the group represented by R¹¹ is a branched aliphatic hydrocarbon group, from the viewpoint that the group represented by R¹¹ is likely to enter between the molecular chains of the resin, the number of branched chains in the group represented by R¹¹ is preferably 1 to 3, is more preferably 1 or 2, and is still more preferably 1.

In a case where the group represented by R¹¹ is a branched aliphatic hydrocarbon group, from the viewpoint that the group represented by R¹¹ is likely to enter between the molecular chains of the resin and easily acts as a lubricant with respect to the molecular chain of the resin, a main chain of the group represented by R¹¹ preferably contains 5 to 24 carbon atoms, more preferably contains 7 to 22 carbon atoms, and still more preferably contains 9 to 20 carbon atoms, and particularly preferably contains 15 to 18 carbon atoms.

In a case where the group represented by R¹¹ is an aliphatic hydrocarbon group containing an alicyclic ring, from the viewpoint that the group represented by R¹¹ is likely to enter between the molecular chains of the resin, the number of alicyclic rings in the group represented by R¹¹ is preferably 1 or 2, and is more preferably 1.

In a case where the group represented by R¹¹ is an aliphatic hydrocarbon group containing an alicyclic ring, from the viewpoint that the group represented by R¹¹ is likely to enter between the molecular chains of the resin, the alicyclic ring in the group represented by R¹¹ is preferably an alicyclic ring having 3 or 4 carbon atoms, and is more preferably an alicyclic ring having 3 carbon atoms.

From the viewpoint of further improving the chemical resistance of the resin molded article, the group represented by R¹¹ is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and is particularly preferably a linear saturated aliphatic hydrocarbon group. The preferable number of carbon atoms in these aliphatic hydrocarbon groups is as described above.

The group represented by R¹¹ may be a group in which a hydrogen atom in an aliphatic hydrocarbon group is substituted with a halogen atom (for example, a fluorine atom, a bromine atom, and an iodine atom), an oxygen atom, a nitrogen atom or the like, and is preferably an unsubstituted group.

R¹² represents an aliphatic hydrocarbon group having 9 to 28 carbon atoms. As the group represented by R¹², the same forms as those described for R¹¹ may be mentioned. Here, the number of carbon atoms of the group represented by R¹² is preferably as follows.

From the viewpoint that the group represented by R¹² is likely to act as a lubricant with respect to the molecular chain of the resin, the group represented by R¹² is preferably an aliphatic hydrocarbon group having 10 carbon atoms or more, is more preferably an aliphatic hydrocarbon group having 11 carbon atoms or more, and is still more preferably an aliphatic hydrocarbon group having 16 carbon atoms or more. From the viewpoint that the group represented by R¹² is likely to enter between the molecular chains of the resin, the group represented by R¹² is preferably an aliphatic hydrocarbon group having 24 carbon atoms or less, is more preferably an aliphatic hydrocarbon group having 20 carbon atoms or less, and is still more preferably an aliphatic hydrocarbon group having 18 carbon atoms or less. The group represented by R¹² is particularly preferably an aliphatic hydrocarbon group having 18 carbon atoms.

From the viewpoint of further improving the chemical resistance of the resin molded article, the group represented by R¹² is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and is particularly preferably a linear saturated aliphatic hydrocarbon group. The preferable number of carbon atoms in these aliphatic hydrocarbon groups is as described above.

The specific forms and preferable forms of the groups represented by R²¹, R²², R³¹, R³², R⁴¹, R⁴², R⁴³, R⁵¹, R⁵², R⁵³ and R⁵⁴ are the same as those described for R¹¹.

Hereinafter, specific examples of the aliphatic hydrocarbon group having 7 to 28 carbon atoms represented by R¹¹, R²¹, R²², R³¹, R³², R⁴¹, R⁴², R⁴³, R⁵¹, R⁵², R⁵³, and R⁵⁴, and specific examples of the aliphatic hydrocarbon group having 9 to 28 carbon atoms represented by R¹² will be described, but the exemplary embodiment is not limited thereto.

R¹¹, R¹², R²¹, R²², R³¹, R³², R⁴¹, R⁴², R⁴³, R⁵¹, R⁵², R⁵³, R⁵⁴
Linear and saturated

| | | |
|---|---|---|
| —C₆H₁₂CH₃ | —C₁₂H₂₄CH₃ | —C₁₉H₃₈CH₃ |
| —C₇H₁₄CH₃ | —C₁₄H₂₈CH₃ | —C₂₀H₄₀CH₃ |
| —C₈H₁₆CH₃ | —C₁₅H₃₀CH₃ | —C₂₁H₄₂CH₃ |
| —C₉H₁₈CH₃ | —C₁₆H₃₂CH₃ | —C₂₃H₄₆CH₃ |
| —C₁₀H₂₀CH₃ | —C₁₇H₃₄CH₃ | —C₂₅H₅₀CH₃ |
| —C₁₁H₂₂CH₃ | —C₁₈H₃₆CH₃ | —C₂₇H₅₄CH₃ |

R¹¹, R¹², R²¹, R²², R³¹, R³², R⁴¹, R⁴², R⁴³, R⁵¹, R⁵², R⁵³, R⁵⁴
Linear and unsaturated

| | |
|---|---|
| —CH═CH—C₄H₈CH₃ | —C₂H₄—CH═CH—C₂H₄CH₃ |
| —CH═CH—C₆H₁₂CH₃ | —C₄H₈—CH═CH—C₄H₈CH₃ |
| —CH═CH—C₈H₁₆CH₃ | —C₅H₁₀—CH═CH—C₅H₁₀CH₃ |
| —CH═CH—C₁₄H₂₈CH₃ | —C₆H₁₂—CH═CH—C₆H₁₂CH₃ |
| —CH═CH—C₁₅H₃₀CH₃ | —C₇H₁₄—CH═CH—C₃H₆CH₃ |
| —CH═CH—C₁₆H₃₂CH₃ | —C₇H₁₄—CH═CH—C₅H₁₀CH₃ |
| —CH═CH—C₁₇H₃₄CH₃ | —C₇H₁₄—CH═CH—C₇H₁₄CH₃ |
| —CH═CH—C₁₈H₃₆CH₃ | —C₇H₁₄—CH═CH—C₈H₁₆CH₃ |
| —CH═CH—C₂₀H₄₀CH₃ | —C₇H₁₄—CH═CH—C₉H₁₈CH₃ |
| —CH═CH—C₂₅H₅₀CH₃ | —C₈H₁₆—CH═CH—C₈H₁₆CH₃ |
| —C₅H₁₀—CH═CH₂ | —C₉H₁₈—CH═CH—C₅H₁₀CH₃ |
| —C₇H₁₄—CH═CH₂ | —C₉H₁₈—CH═CH—C₇H₁₄CH₃ |
| —C₁₅H₃₀—CH═CH₂ | —C₁₀H₂₀—CH═CH—C ₁₂H₂₄CH₃ |
| —C₁₆H₃₂—CH═CH₂ | —C₁₀H₂₀—CH═CH—C₁₅H₃₀CH₃ |
| —C₁₇H₃₄—CH═CH₂ | —C₁₁H₂₂—CH═CH—C₇H₁₄CH₃ |
| —C₁₈H₃₆—CH═CH₂ | —C₁₂H₂₄—CH═CH—C₁₂H₂₄CH₃ |
| —C₂₁H₄₂—CH═CH₂ | —C₁₃H₂₆—CH═CH—C₇H₁₄CH₃ |
| —C₂₆H₅₂—CH═CH₂ | —CH₂—CH═CH—C₇H₁₄—CH═CH—C₇H₁₄CH₃ |
| —CH₂—CH═CH—C₃H₆CH₃ | —C₇H₁₄—CH═CH—CH₂—CH═CH—C₄H₈CH₃ |
| —CH₂—CH═CH—C₇H₁₄CH₃ | —C₇H₁₄—CH═CH—C₇H₁₄—CH═CH—C₇H₁₄CH₃ |
| —CH₂—CH═CH—C₁₀H₂₀CH₃ | —C₇H₁₄—CH═CH—C₉H₁₈—CH═CH—C₇H₁₄CH₃ |
| —CH₂—CH═CH—C₁₆H₃₂CH₃ | —C₇H₁₄—CH═CH—CH₂—CH═CH—CH₂—CH═CH—CH₂CH₃ |
| —CH₂—CH═CH—C₂₄H₄₈CH₃ | —CH═CH—C₇H₁₄—CH═CH—C₇H₁₄—CH═CH—C₇H₁₄CH₃ |

R¹¹, R¹², R²¹, R²², R³¹, R³², R⁴¹, R⁴², R⁴³, R⁵¹, R⁵², R⁵³, R⁵⁴
Branched and saturated

| | |
|---|---|
| —C₅H₁₀—CH(CH₃)₂ | —CH(C₂H₅)—C₇H₁₄CH₃ |
| —C₁₀H₂₀—CH(CH₃)₂ | —CH(C₂H₅)—C₁₄H₂₈CH₃ |
| —C₁₄H₂₈—CH(CH₃)₂ | —CH(C₂H₅)—C₁₆H₃₂CH₃ |
| —C₁₅H₃₀—CH(CH₃)₂ | —CH(C₂H₅)—C₁₈H₃₆CH₃ |
| —C₁₆H₃₂—CH(CH₃)₂ | —CH(C₄H₉)—C₁₅H₃₀CH₃ |
| —C₁₇H₃₄—CH(CH₃)₂ | —CH(C₆H₁₃)—C₁₂H₂₄CH₃ |
| —C₂₀H₄₀—CH(CH₃)₂ | —CH(C₆H₁₃)—C₁₄H₂₈CH₃ |
| —C₂₅H₅₀—CH(CH₃)₂ | —CH(C₆H₁₃)—C₁₆H₃₂CH₃ |
| —C₆H₁₂—C(CH₃)₃ | —CH₂—CH(CH₃)—C₃H₆CH₃ |
| —C₁₀H₂₀—C(CH₃)₃ | —CH₂—CH(CH₃)—C₆H₁₂CH₃ |
| —C₁₄H₂₈—C(CH₃)₃ | —CH₂—CH(CH₃)—C₈H₁₆CH₃ |
| —C₁₅H₃₀—C(CH₃)₃ | —CH₂—CH(CH₃)—C₁₂H₂₄CH₃ |
| —C₁₆H₃₂—C(CH₃)₃ | —CH₂—CH(CH₃)—C₁₆H₃₂CH₃ |
| —CH(CH₃)—C₅H₁₀CH₃ | —CH₂—CH(CH₃)—C₂₀H₄₀CH₃ |
| —CH(CH₃)—C₁₀H₂₀CH₃ | —CH₂—CH(CH₃)—C₂₄H₄₈CH₃ |
| —CH(CH₃)—C₁₃H₂₆CH₃ | —CH₂—CH(C₆H₁₃)₂ |
| —CH(CH₃)—C₁₄H₂₈CH₃ | —CH₂—CH(C₆H₁₃)—C₇H₁₄CH₃ |
| —CH(CH₃)—C₁₅H₃₀CH₃ | —CH₂—CH(C₆H₁₃)—C₉H₁₈CH₃ |
| —CH(CH₃)—C₁₆H₃₂CH₃ | —CH₂—CH(C₆H₁₃)—C₁₂H₂₄CH₃ |
| —CH(CH₃)—C₁₇H₃₄CH₃ | —CH₂—CH(C₆H₁₃)—C₁₅H₃₀CH₃ |
| —CH(CH₃)—C₁₈H₃₆CH₃ | —CH₂—CH(C₈H₁₇)—C₁₉H₃₈CH₃ |
| —CH(CH₃)—C₂₂H₄₄CH₃ | —CH₂—CH(C₈H₁₇)—C₉H₁₈CH₃ |
| —CH(CH₃)—C₂₅H₅₀CH₃ | —CH₂—CH(C₁₀H₂₁)—C₁₂H₂₄CH₃ |

—C₂H₄—CH(CH₃)—C₃H₆—CH(CH₃)—C₃H₆—CH(CH₃)—C₃H₆—CH(CH₃)₂

R¹¹, R¹², R²¹, R²², R³¹, R³², R⁴¹, R⁴², R⁴³, R⁵¹, R⁵², R⁵³, R⁵⁴
Branched and unsaturated

| | |
|---|---|
| —CH═CH—C₅H₁₀—CH(CH₃)₂ | —CH₂—CH═CH—CH(CH₃)—CH₂CH₃ |
| —CH═CH—C₁₂H₂₄—CH(CH₃)₂ | —CH₂—CH═CH—CH(CH₃)—C₃H₆CH₃ |
| —CH═CH—C₁₅H₃₀—CH(CH₃)₂ | —CH₂—CH═CH—CH(CH₃)—C₇H₁₄CH₃ |
| —CH═CH—C₁₆H₃₂—CH(CH₃)₂ | —CH₂—CH═CH—CH(CH₃)—C₁₆H₃₂CH₃ |
| —CH═CH—C₁₈H₃₆—CH(CH₃)₂ | —CH₂—CH═CH—CH(CH₃)—C₂₂H₄₄CH₃ |
| —CH═CH—C₂₃H₄₆—CH(CH₃)₂ | —CH₂—CH═CH—CH₂—CH(CH₃)—CH₂CH₃ |
| —CH═CH—C₇H₁₄—C(CH₃)₃ | —CH₂—CH═CH—C₂H₄—CH(CH₃)—C₂H₄CH₃ |
| —CH═CH—C₁₂H₂₄—C(CH₃)₃ | —CH₂—CH═CH—C₂H₄—CH(CH₃)—C₄H₈CH₃ |
| —CH═CH—C₁₄H₂₈—C(CH₃)₃ | —CH₂—CH═CH—C₆H₁₂—CH(CH₃)—C₆H₁₂CH₃ |
| —CH═CH—C₁₆H₃₂—C(CH₃)₃ | —CH₂—CH═CH—C₇H₁₄—CH(CH₃)—C₇H₁₄CH₃ |
| —CH═CH—C₂₀H₄₀—C(CH₃)₃ | —CH₂—CH═CH—C₇H₁₄—CH(CH₃)—C₈H₁₆CH₃ |
| —CH═CH—CH(C₈H₁₇)₂ | —CH₂—CH═CH—CH₂—CH═CH—CH(CH₃)—C₃H₆CH₃ |
| —CH═CH—CH(C₆H₁₃)—C₇H₁₄CH₃ | —CH₂—CH═CH—CH₂—CH═CH—CH(CH₃)—C₇H₁₄CH₃ |
| —CH═CH—CH(C₆H₁₃)—C₁₁H₂₂CH₃ | —CH₂—CH═CH—CH₂—CH═CH—CH(CH₃)—C₁₆H₃₂CH₃ |
| —CH═CH—CH(C₈H₁₇)—C₉H₁₈CH₃ | —CH₂—CH═CH—CH(CH₃)—CH═CH—CH₂—C₃H₆CH₃ |
| —CH═CH—CH(C₈H₁₇)—C₁₂H₂₄CH₃ | —CH₂—CH═CH—CH(CH₃)—CH═CH—CH₂—C₇H₁₄CH₃ |
| —C₃H₆—CH═CH—C₅H₁₀—CH(CH₃)₂ | —CH₂—CH═CH—CH(C₂H₅)—CH═CH—CH₂—C₇H₁₄CH₃ |
| —C₇H₁₄—CH═CH—C₆H₁₂—CH(CH₃)₂ | —CH₂—CH═CH—CH(CH₃)—CH═CH—CH₂—C₁₆H₃₂CH₃ |
| —C₇H₁₄—CH═CH—C₇H₁4—CH(CH₃)₂ | —CH₂—CH═CH—CH(C₂H₅)—CH═CH—CH₂—C₁₆H₃₂CH₃ |
| —C₈H₁₆—CH═CH—C₆H₁₂—CH(CH₃)₂ | —CH₂—CH═CH—CH(CH₃)—CH═CH—CH₂—C₁₉H₃₈CH₃ |
| —C₈H₁₆—CH═CH—C₇H₁₄—CH(CH₃)₂ | —CH₂—CH═CH—CH(CH₃)—CH═CH—CH(CH₃)—CH₂CH₃ |
| —CH(CH₃)—C₁₄H₂₈—CH═CH₂ | —CH₂—CH═CH—CH(CH₃)—CH═CH—CH(CH₃)—C₃H₆CH₃ |
| —CH(CH₃)—C₁₆H₃₂—CH═CH₂ | —CH₂—CH═CH—CH(CH₃)—CH═CH—CH(CH₃)—C₇H₁₄CH₃ |
| —CH(C₂H₅)—C₁₄H₂₈—CH═CH₂ | —CH₂—CH═CH—CH(C₂H₅)—CH═CH—CH(C₂H₅)—C₇H₁₄CH₃ |
| —CH(C₂H₅)—C₁₆H₃₂—CH═CH₂ | —CH₂—CH═CH—CH(CH₃)—CH═CH—CH(CH₃)—C₁₂H₂₄CH₃ |
| —CH(C₄H₉)—C₁₄H₂₈—CH═CH₂ | —CH₂—CH═CH—CH(CH₃)—CH═CH—CH(CH₃)—C₁₅H₃₀CH₃ |
| —CH(C₆H₁₃)—C₁₀H₂₀—CH═CH₂ | —CH₂—CH═CH—CH(CH₃)—CH═CH—CH(CH₃)—C₁₈H₃₆CH₃ |
| —CH(C₆H₁₃)—C₁₂H₂₄—CH═CH₂ | —C₄H₈—CH═CH—C₄H₈—CH═CH—C₄H₈—CH(CH₃)₂ |
| —CH₂—CH(C₆H₁₃)—C₇H₁₄—CH═CH₂ | —C₇H₁₄—CH═CH—C₇H₁₄—CH═CH—C₇H₁₄—CH(CH₃)₂ |

Ester compound (B) may be used alone or two or more kinds thereof may be used in combination.

[Plasticizer (C): Component (C)]

From the viewpoint of the chemical resistance in the obtained resin molded article, the resin composition according to the exemplary embodiment preferably further contains plasticizer (C).

Examples of plasticizer (C) include a cardanol compound, an ester compound other than ester compound (B), camphor, metal soap, polyol, and polyalkylene oxide. As plasticizer (C), a cardanol compound is preferable from the viewpoint of the chemical resistance of the resin molded article, and from the viewpoint of the chemical resistance of the resin molded article, an ester compound other than ester compound (B) is preferable.

Plasticizer (C) may be used alone or two or more kinds thereof may be used in combination.

From the viewpoint that it is easy to obtain the effect of improving the chemical resistance by adding ester compound (B), plasticizer (C) is preferably a cardanol compound or an ester compound other than ester compound (B). Hereinafter, the cardanol compound and the ester compound suitable as plasticizer (C) will be specifically described.

—Cardanol Compound—

The cardanol compound refers to a component (for example, a compound represented by Formulae (c-1) to (c-4)) contained in a nature derived-compounds derived from a cashew, or a derivative from the above-described component.

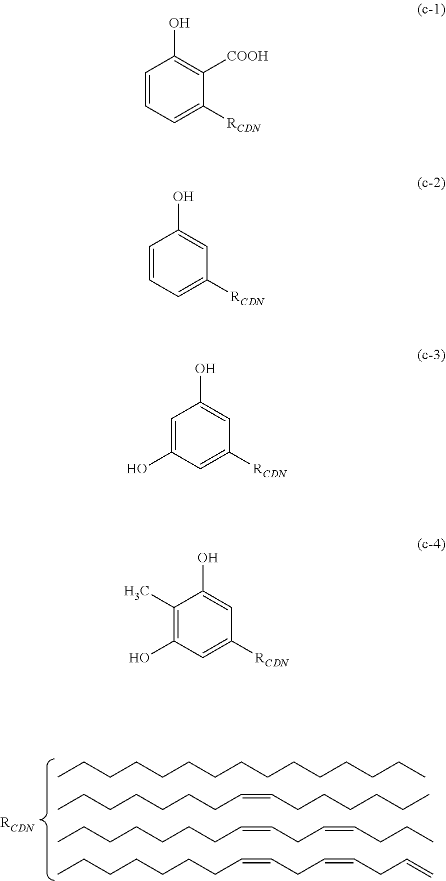

The cardanol compound may be used alone or two or more kinds thereof may be used in combination.

The resin composition according to the exemplary embodiment may contain a mixture of nature derived-compounds derived from a cashew as a cardanol compound (hereinafter, also referred to as “cashew-derived mixture”).

The resin composition according to this exemplary embodiment may contain a derivative from a cashew-derived mixture as a cardanol compound. As the derivative from the cashew-derived mixture, for example, the following mixtures and pure substances may be exemplified.
A mixture prepared by adjusting the composition ratio of each component in the cashew-derived mixture
A pure substance which is a specific component isolated from the cashew-derived mixture
A mixture containing a modified product obtained by modifying components in the cashew-derived mixture
A mixture containing a polymer obtained by polymerizing components in the cashew-derived mixture
A mixture containing a modified polymer obtained by modifying and polymerizing a component in the cashew-derived mixture
A mixture containing a modified product obtained by further modifying components in the mixture prepared by adjusting the composition ratio of each component in the cashew-derived mixture
A mixture containing a polymer obtained by further polymerizing the components in the mixture prepared by adjusting the composition ratio of each component in the cashew-derived mixture
A mixture containing a modified polymer obtained by further modifying and polymerizing the components in the mixture prepared by adjusting the composition ratio of each component in the cashew-derived mixture
Modified product obtained by further isolating the pure substance
A polymer obtained by further polymerizing the pure substance
A modified polymer obtained by further modifying and polymerizing the pure substance

Here, a pure substance includes a multimer such as a dimer and a trimer.

From the viewpoint of the chemical resistance of the resin molded article, the cardanol compound is preferably at least one compound selected from the group consisting of polymers obtained by polymerizing a compound represented by Formula (CDN1) and a compound represented by Formula (CDN1).

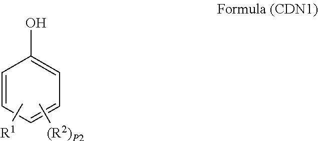

In Formula (CDN1), R¹ represents an alkyl group which may have a substituent or an unsaturated aliphatic group which has a double bond and may have a substituent. R² represents a hydroxy group, a carboxy group, an alkyl group which may have a substituent, or an unsaturated aliphatic group which has a double bond and may have a substituent. P2 represents an integer of 0 to 4. Each of R² present in plural in a case where P2 is 2 or more may be the same group or different group.

In Formula (CDN1), the alkyl group which may have a substituent represented by R¹ is preferably an alkyl group having 3 to 30 carbon atoms, is more preferably an alkyl group having 5 to 25 carbon atoms, is still more preferably an alkyl group having 8 to 20 carbon atoms.

Examples of the substituent include a hydroxy group; a substituent containing an ether bond such as an epoxy group and a methoxy group; and a substituent containing an ester bond such as an acetyl group and a propionyl group.

Examples of the alkyl group which may have a substituent include a pentadecan-1-yl group, a heptan-1-yl group, an octan-1-yl group, a nonan-1-yl group, a decan-1-yl group, an undecan-1-yl group, a dodecan-1-yl group, and a tetradecan-1-yl group.

In Formula (CDN1), the unsaturated aliphatic group which has a double bond and may have a substituent represented by R¹ is preferably an unsaturated aliphatic group having 3 to 30 carbon atoms, is more preferably an unsaturated aliphatic group having 5 to 25 carbon atoms, and is still more preferably an unsaturated aliphatic group having 8 to 20 carbon atoms.

The number of double bonds contained in the unsaturated aliphatic group is preferably 1 to 3.

Examples of the substituent include the same substituents as those of the alkyl group.

Examples of the unsaturated aliphatic group which has a double bond and may have a substituent include a pentadeca-8-en-1-yl group, a pentadeca-8,11-dien-1-yl group, a pentadeca-8, 11, 14-trien-1-yl group, a pentadeca-7-en-1-yl group, a pentadeca-7,10-dien-1-yl group, and a pentadeca-7,10,14-trien-1-yl group.

In Formula (CDN1), as R¹, a pentadeca-8-en-1-yl group, a pentadeca-8,11-dien-1-yl group, a pentadeca-8, 11, 14-trien-1-yl group, a pentadeca-7-en-1-yl group, a pentadeca-7,10-dien-1-yl group, and a pentadeca-7,10,14-trien-1-yl group are preferable.

In Formula (CDN1), preferable examples of the alkyl group which may have a substituent and the unsaturated aliphatic group which has a double bond and may have a substituent, which are represented by R², are the same as those of the alkyl group which may have a substituent and the unsaturated aliphatic group which has a double bond and may have a substituent, which are represented by R¹.

The compound represented by Formula (CDN1) may be further modified. For example, it may be epoxidized, specifically, the compound represented by Formula (CDN1) may be a compound having a structure in which the hydroxy group of the compound represented by Formula (CDN1) is replaced with the following group (EP), that is, a compound represented by the following Formula (CDN1-e).

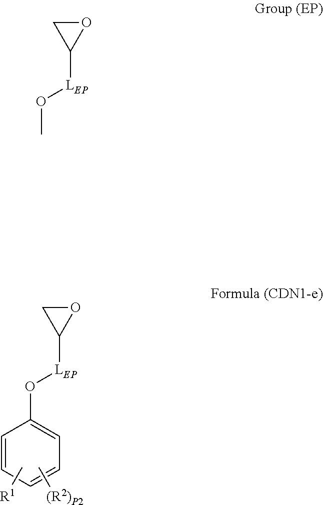

In group (EP) and Formula (CDN1-e), L_{EP} represents a single bond or a divalent linking group. In Formula (CDN1-e), each of the R¹, R², and P2 is the same as R¹, R², and P2 in Formula (CDN1), respectively.

In group (EP) and Formula (CDN1-e), examples of the divalent linking group represented by L_{EP} include an alkylene group which may have a substituent (preferably an alkylene group having 1 to 4 carbon atoms, and more preferably an alkylene group having 1 carbon atom), and a —CH₂CH₂OCH₂CH₂— group.

Examples of the substituent include the same substituents as those in R¹ of Formula (CDN1).

As L_{EP}, a methylene group is preferable.

The polymer in which the compound represented by Formula (CDN1) is polymerized is a polymer in which at least two or more compounds represented by Formula (CDN1) are polymerized with or without a linking group.

As a polymer obtained by polymerizing a compound represented by Formula (CDN1), for example, a compound represented by Formula (CDN2) may be exemplified.

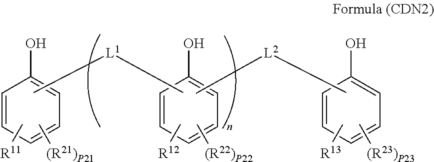

In Formula (CDN2), R¹¹, R¹², and R¹³ each independently represents an alkyl group which may have a substituent or an unsaturated aliphatic group which has a double bond and may have a substituent. R²¹, R²² and R²³ each independently represents a hydroxy group, a carboxy group, an alkyl group which may have a substituent, or an unsaturated aliphatic group which has a double bond and may have a substituent. P21 and P23 each independently represent an integer of 0 to 3, and P22 represents an integer of 0 to 2. L¹ and L² each independently represent a divalent linking group. n represents an integer of 0 to 10. R²¹ present in plural in a case where P21 is 2 or more may be the same group or different group, R²² present in plural in a case where P22 is 2 or more may be the same group or different group, and R²³ present in plural in a case where P23 is 2 or more may be the same group or different group. R¹² present in plural in a case where n is 2 or more may be the same group or different group, R²² present in plural in a case where n is 2 or more may be the same group or different group, L¹ present in plural in a case where n is 2 or more may be the same group or different group, and P22 present in plural in a case where n is 2 or more may be the same number or different numbers.

In Formula (CDN2), as the alkyl group which may have a substituent and the unsaturated aliphatic group which has a double bond and may have a substituent, which are represented by R¹¹, R¹², R¹³, R²¹, R²², and R²³, the same groups exemplified as R¹ in Formula (CDN1) are preferably exemplified.

In Formula (CDN2), examples of the divalent linking group represented by L¹ and L² include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

In Formula (CDN2), n is preferably 1 to 10, and is more preferably 1 to 5.

The compound represented by Formula (CDN2) may be further modified. For example, it may be epoxidized, specifically, a compound having a structure in which the hydroxy group of the compound represented by Formula (CDN2) is replaced with the group (EP), that is, a compound represented by the following Formula (CDN2-e).

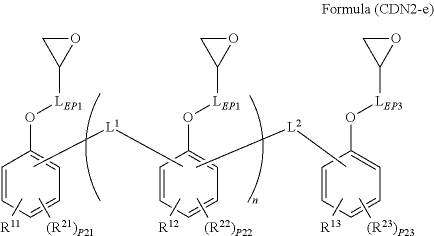

In Formula (CDN2-e), each of R¹¹, R¹², R¹³, R²¹, R²², R²³, P21, P22, P23, L¹, L² and n is the same as R¹¹, R¹², R¹³, R²¹, R²², R²³, P21, P22, P23, L¹, and L² and n in Formula (CDN2).

In Formula (CDN2-e), L_{EP1}, L_{EP2}, and L_{EP3} each independently represent a single bond or a divalent linking group. Each of L_{EP2} present in plural in a case where n is 2 or more may be the same group or different group.

In Formula (CDN2-e), as the divalent linking group represented by L_{EP1}, L_{EP2}, and L_{EP3}, the same groups exemplified as the divalent linking group represented by L_{EP} in Formula (CDN1-e) are preferably exemplified.

The polymer in which the compound represented by Formula (CDN1) is polymerized may be, for example, a polymer in which at least three or more compounds represented by Formula (CDN1) are three-dimensionally crosslinked and polymerized with or without a linking group. Examples of the polymer in which the compound represented by Formula (CDN1) is three-dimensionally crosslinked and polymerized include compounds represented by the following Formula.

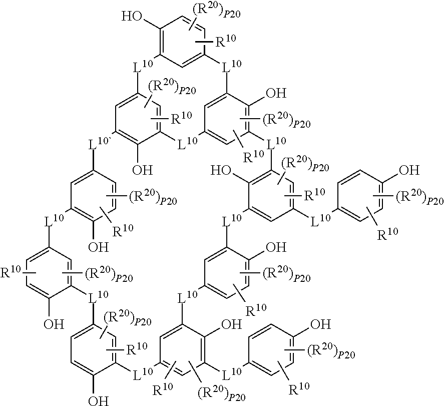

In the Formula, each of the R¹⁰, R²⁰, and P20 is the same as R¹, R², and P2 in Formula (CDN1). L¹⁰ represents a single bond or a divalent linking group. R¹⁰ present in plural may be the same group or different group, R²⁰ present in plural may be the same group or different group, and L¹⁰ present in plural may be the same group or different group. P20 present in plural may be the same number or different numbers.

In the Formula, examples of the divalent linking group represented by L¹⁰ include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

The compound represented by the Formula may be further modified, for example, it may be epoxidized. Specifically, it may be a compound having a structure in which the hydroxy group of the compound represented by the Formula is substituted with the group (EP), and examples thereof include compounds represented by the following Formula, that is, polymer in which the compound represented by Formula (CDN1-e) is three-dimensionally crosslinked and polymerized.

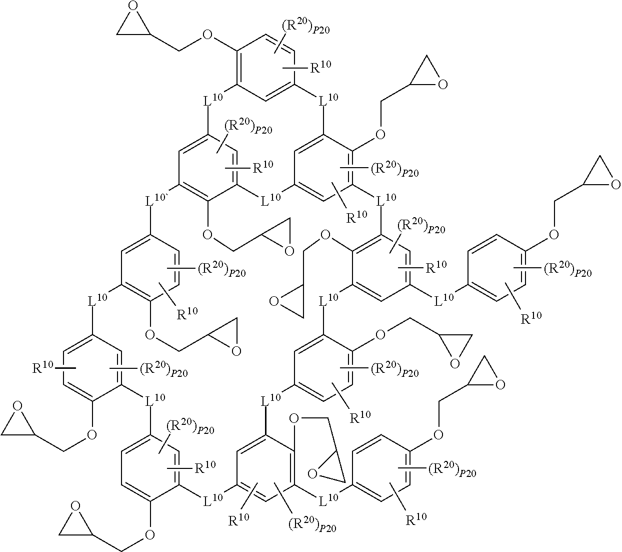

In the Formula, each of the R¹⁰, R²⁰, and P20 is the same as R¹, R², and P2 in Formula (CDN1-e). L¹⁰ represents a single bond or a divalent linking group. R¹⁰ present in plural may be the same group or different group, R²⁰ present in plural may be the same group or different group, and L¹⁰ present in plural may be the same group or different group. P20 present in plural may be the same number or different numbers.

In the Formula, examples of the divalent linking group represented by L¹⁰ include an alkylene group which may have a substituent (preferably an alkylene group having 2 to 30 carbon atoms, and more preferably an alkylene group having 5 to 20 carbon atoms).

Examples of the substituent include the same substituents as those in R¹ of Formula (CDN1).

From the viewpoint of improving the chemical resistance of the resin molded article, the cardanol compound preferably contains a cardanol compound having an epoxy group, and is more preferably a cardanol compound having an epoxy group.

As the cardanol compound, commercially available products may be used. Examples of the commercially available products include NX-2024, Ultra LITE 2023, NX-2026, GX-2503, NC-510, LITE 2020, NX-9001, NX-9004, NX-9007, NX-9008, NX-9201, and NX-9203, which are prepared by Cardolite, and LB-7000, LB-7250, and CD-5L which are prepared by Tohoku Chemical Industries, Ltd.

Examples of the commercially available products of the cardanol compound having an epoxy group include NC-513, NC-514S, NC-547, LITE513E, and Ultra LTE 513, which are prepared by Cardolite.

From the viewpoint of the chemical resistance of the resin molded article, a hydroxyl value of the cardanol compound is preferably 100 mgKOH/g or more, is more preferably 120 mgKOH/g or more, and is still more preferably 150 mgKOH/g or more. The measurement of the hydroxyl value of the cardanol compound is performed in accordance with an A method of ISO14900.

In a case where a cardanol compound having an epoxy group is used as a cardanol compound, from the viewpoint of improving the chemical resistance of the resin molded article, an epoxy equivalent is preferably 300 to 500, is more preferably 350 to 480, and is still more preferably 400 to 470. The measurement of the epoxy equivalent of the cardanol compound having an epoxy group is performed in accordance with ISO3001.

—Ester Compound—

An ester compound contained in the resin composition according to the exemplary embodiment as plasticizer (C) is not particularly limited as long as it is an ester compound other than the compound represented by Formulae (1) to (5).

Examples of the ester compound contained as plasticizer (C) include dicarboxylic acid diester, citric acid ester, a polyetherester compound, benzoic acid glycol ester, a compound represented by Formula (6), and epoxidized fatty acid ester. Examples of these esters include monoesters, diesters, triesters, and polyesters.

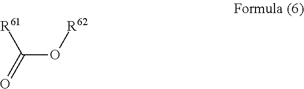

In Formula (6), R⁶¹ represents an aliphatic hydrocarbon group having 7 to 28 carbon atoms and R⁶² represents an aliphatic hydrocarbon group having 1 to 8 carbon atoms.

As a specific form and preferable form of the group represented by R⁶¹, the same form as that of the group represented by R¹¹ in Formula (1) is exemplified.

The group represented by R⁶² may be a saturated aliphatic hydrocarbon group or an unsaturated aliphatic hydrocarbon group, and is preferably a saturated aliphatic hydrocarbon group. The group represented by R⁶² may be a linear aliphatic hydrocarbon group, may be a branched aliphatic hydrocarbon group, may be an aliphatic hydrocarbon group containing an alicyclic ring, and is preferably a linear aliphatic hydrocarbon group. The group represented by R⁶² may be a group in which a hydrogen atom in an aliphatic hydrocarbon group is substituted with a halogen atom (for example, a fluorine atom, a bromine atom, and an iodine atom), an oxygen atom, a nitrogen atom, and is preferably an unsubstituted group. The group represented by R⁶² preferably has 2 or more carbon atoms, more preferably has 3 or more carbon atoms, and still more preferably has 4 or more carbon atoms.

Specific examples of the ester compound contained as plasticizer (C) include adipic acid ester, citric acid ester, sebacic acid ester, azelaic acid ester, phthalic acid ester, acetic ester, dibasic acid ester, phosphate ester, condensed phosphate ester, glycol ester (for example, benzoic acid glycol ester), and a modified product of fatty acid ester (for example, epoxidized fatty acid ester). Examples of the above ester include monoester, diester, triester, and polyester. Among them, dicarboxylic acid diester (adipic acid diester, sebacic acid diester, azelaic acid diester, phthalic acid diester, and the like) are preferable.

As plasticizer (C), adipic acid ester is preferable. The adipic acid ester has high affinity with resin, particularly cellulose acylate (A), and disperses in a state of nearly uniform to the resin, particularly cellulose acylate (A), so that the thermal fluidity is improved more than other plasticizers.

In the ester compound contained in the resin composition according to the exemplary embodiment as plasticizer (C), the molecular weight (or weight average molecular weight) is preferably 200 to 2000, is more preferably 250 to 1500, and is still more preferably 280 to 1000. The weight average molecular weight of the ester compound is a value measured according to the method of measuring the weight average molecular weight of cellulose acylate (A), unless otherwise specified.

Examples of the adipic acid ester include adipic acid diester and adipic acid polyester. Specific examples thereof include adipic acid diester represented by Formula (AE) and adipic acid polyester represented by Formula (APE).

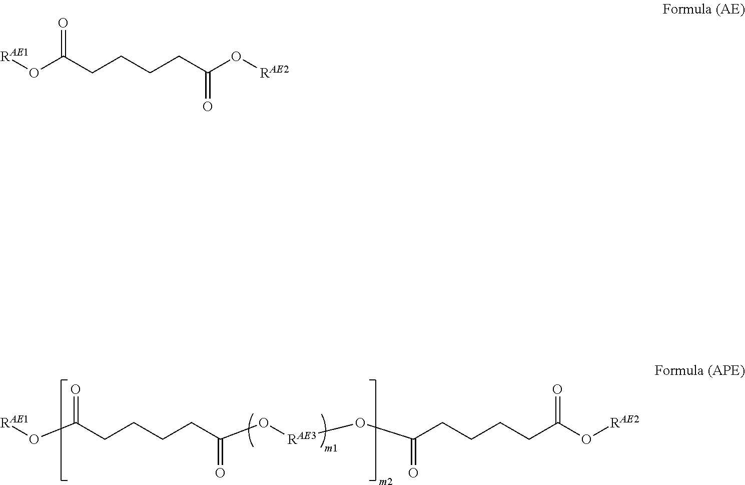

In Formula (AE), R^{AE1} and R^{AE2} each independently represent an alkyl group or a polyoxyalkyl group [—(CₓH₂ₓ—O)_{y}—R^{A1}] (here, R^{A1} represents an alkyl group, x represents an integer of 1 to 10, and y represents an integer of 1 to 10).

In Formula (APE), R^{AE1} and R^{AE2} each independently an alkyl group or a polyoxyalkyl group [—(CₓH₂ₓ—O)_{y}—R^{A1}] (here, R^{A1} represents an alkyl group, x represents an integer of 1 to 10, and y represents an integer of 1 to 10), and R^{AE3} represents an alkylene group.

m1 represents an integer of 1 to 10 and m2 represents an integer of 1 to 20.

In Formula (AE) and (APE), an alkyl group represented by R^{AE1} and R^{AE2} is preferably an alkyl group having 1 to 12 carbon atoms, is more preferably an alkyl group having 4 to 10 carbon atoms, and is still more preferably an alkyl group having 8 carbon atoms. The alkyl group represented by R^{AE1} and R^{AE2} may be any one of a linear alkyl group, a branched alkyl group, and a cyclic alkyl group, and is preferably a linear alkyl group or a branched alkyl group.

In Formula (AE) and (APE), in the polyoxyalkyl group [—(CₓH₂ₓ—O)_{y}—R^{A1}] represented by R^{AE1} and R^{AE2}, an alkyl group represented by R^{A1} is preferably an alkyl group having 1 to 6 carbon atoms, and is more preferably an alkyl group having 1 to 4 carbon atoms. The alkyl group represented by R^{A1} may be any one of a linear alkyl group, a branched alkyl group, and a cyclic alkyl group, and is preferably a linear alkyl group or a branched alkyl group.

In Formula (APE), an alkylene group represented by R^{AE3} is preferably an alkylene group having 1 to 6 carbon atoms and is more preferably an alkylene group having 1 to 4 carbon atoms. The alkylene group may be any one of a linear alkyl group, a branched alkyl group, and a cyclic alkyl group, and is preferably a linear alkyl group or a branched alkyl group.

In Formula (APE), m1 is preferably an integer of 1 to 5 and m2 is preferably an integer of 1 to 10.

In Formula (AE) and (APE), the group represented by each code may be substituted with a substituent. Examples of the substituent include an alkyl group, an aryl group, and a hydroxy group.

The molecular weight of adipic acid ester (or weight average molecular weight) is preferably 250 to 2000, is more preferably 280 to 1500, and still more preferably 300 to 1000. The weight average molecular weight of adipic acid ester is a value measured according to the method of measuring the weight average molecular weight of cellulose acylate (A).

As the adipic acid ester, a mixture of adipic acid ester and other components may be used. As a commercially available product of the mixture, Daifatty 101 prepared by Daihachi Chemical Industry Co., Ltd., and the like may be mentioned.

As a hydrocarbon group at a terminal in fatty acid ester such as citric acid ester, sebacic acid ester, azelaic acid diester, phthalic acid ester, and acetic acid ester, an aliphatic hydrocarbon group is preferable, an alkyl group having 1 to 12 carbon atoms is preferable, an alkyl group having 4 to 10 carbon atoms is more preferable, and an alkyl group having 8 carbon atoms is still more preferable. The alkyl group may be any one of a linear alkyl group, a branched alkyl group, and a cyclic alkyl group, and is preferably a linear alkyl group or a branched alkyl group.

Examples of the fatty acid ester such as citric acid ester, sebacic acid ester, azelaic acid diester, phthalic acid ester, and acetic acid ester include ester of fatty acid and alcohol. Examples of alcohol include monohydric alcohols such as methanol, ethanol, propanol, butanol, and 2-ethyl hexanol; and polyhydric alcohol such as glycerin, polyglycerine (diglycerin and the like), pentaerythritol, ethylene glycol, diethylene glycol, propylene glycol, butylene glycol, trimethylolpropane, trimethylol ethane, and sugar alcohol.

Examples of glycol in benzoic acid glycol ester include ethylene glycol, diethylene glycol, and propylene glycol.

The epoxidized fatty acid ester is an ester compound having a structure (that is, oxacyclopropane) in which carbon-carbon unsaturated bonds of unsaturated fatty acid esters are epoxidized. Examples of the epoxidized fatty acid ester include ester of fatty acid and alcohol in which some or all of the carbon-carbon unsaturated bonds are epoxidized in the unsaturated fatty acid (for example, oleic acid, palmitoleic acid, vaccenic acid, linoleic acid, linolenic acid, and nervonic acid). Examples of alcohol include monohydric alcohols such as methanol, ethanol, propanol, butanol, and 2-ethyl hexanol; and polyhydric alcohol such as glycerin, polyglycerine (diglycerin and the like), pentaerythritol, ethylene glycol, diethylene glycol, propylene glycol, butylene glycol, trimethylolpropane, trimethylol ethane, and sugar alcohol.

Examples of the commercially available product of the epoxidized fatty acid ester include ADEKA CIZER D-32, D-55, O-130P, and O-180A (prepared by ADEKA CORPORATION), SANSO CIZER E-PS, nE-PS, E-PO, E-4030, E-6000, E-2000H, and E-9000H (prepared by New Japan Chemical Co., Ltd.).

A polyester unit of the polyetherester compound may be either aromatic or aliphatic (including alicyclic) and a polyether unit of the polyetherester compound may be either aromatic or aliphatic (including alicyclic). A weight ratio of the polyester unit to the polyether unit is, for example, 20:80 to 80:20. The molecular weight (or weight average molecular weight) of the polyetherester compound is preferably 250 to 2000, is more preferably 280 to 1500, and still more preferably 300 to 1000. Examples of the commercially available product of the polyetherester compound include ADEKA CIZER RS-1000 (prepared by ADEKA CORPORATION).

As a polyether compound having at least one unsaturated bond in a molecule, a polyether compound having an allyl group at the terminal thereof is exemplified, and polyalkylene glycol allyl ether is preferable. The molecular weight (or weight average molecular weight) of the polyether compound having at least one unsaturated bond in a molecule is preferably 250 to 2000, is more preferably 280 to 1500, and is still more preferably 300 to 1000. Examples of the commercially available product of the polyether compound having at least one unsaturated bond in a molecule include polyalkylene glycol allyl ether such as UNIOX PKA-5006, UNIOX PKA-5008, UNIOL PKA-5014, and UNIOL PKA-5017 (prepared by NOF CORPORATION).

[Thermoplastic Elastomer (D): Component (D)]

From the viewpoint of the chemical resistance in the obtained resin molded article, it is preferable that the resin composition according to the exemplary embodiment further contains thermoplastic elastomer (D). Thermoplastic elastomer (D) is at least one thermoplastic elastomer selected from the group consisting of polymer (d1) with a core-shell structure having a core layer containing a butadiene polymer, and a shell layer containing a polymer selected from a styrene polymer and an acrylonitrile-styrene polymer on the surface of the core layer, polymer (d2) with a core-shell structure having a core layer and a shell layer containing a polymer of alkyl (meth)acrylate on the surface of the core layer, olefin polymer (d3) which is a polymer of α-olefin and alkyl (meth)acrylate, and contains 60% by weight or more of a constitutional unit derived from the α-olefin, styrene-ethylene-butadiene-styrene copolymer (d4), polyurethane (d5), and polyester (d6).

Component (D) is, for example, a thermoplastic elastomer having elasticity at ordinary temperature (25° C.) and softening property at a high temperature similar to a thermoplastic resin.

Among them, from the viewpoint of the chemical resistance in the obtained resin molded article, the resin composition preferably further contains thermoplastic elastomer (D). From the viewpoint of the chemical resistance in the obtained resin molded article, thermoplastic elastomer (D) preferably contains at least one thermoplastic elastomer selected from the group consisting of polymer (d1) with a core-shell structure having a core layer containing a butadiene polymer, and a shell layer containing a polymer selected from a styrene polymer and an acrylonitrile-styrene polymer on the surface of the core layer, polymer (d2) with a core-shell structure having a core layer and a shell layer containing a polymer of alkyl (meth)acrylate on the surface of the core layer, styrene-ethylene-butadiene-styrene copolymer (d4), polyurethane (d5), and polyester (d6), more preferably contains at least one thermoplastic elastomer selected from the group consisting of polymer (d1) with a core-shell structure having a core layer containing a butadiene polymer, and a shell layer containing a polymer selected from a styrene polymer and an acrylonitrile-styrene polymer on the surface of the core layer, polymer (d2) with a core-shell structure having a core layer and a shell layer containing a polymer of alkyl (meth)acrylate on the surface of the core layer, and still more preferably contains polymer (d2) with a core-shell structure having a core layer and a shell layer containing a polymer of alkyl (meth)acrylate on the surface of the core layer.

In addition, from the viewpoint of the chemical resistance in the obtained resin molded article, thermoplastic elastomer (D) is preferably a particulate thermoplastic elastomer. That is, from the viewpoint of the chemical resistance in the obtained resin molded article, the resin composition according to the exemplary embodiment preferably contains thermoplastic elastomer particles as thermoplastic elastomer (D).

(Polymer (d1) with a Core-Shell Structure: Component (d1))

Polymer (d1) with a core-shell structure is a polymer with a core-shell structure having a core layer and a shell layer on the surface of the core layer. Polymer (d1) with core-shell structure is a polymer having a core layer as an innermost layer and a shell layer as an outermost layer (specifically, a polymer in which a shell layer is obtained by graft polymerizing a polymer of alkyl (meth)acrylate to a polymer to be a core layer).

One or more other layers (for example, 1 to 6 other layers) may be provided between the core layer and the shell layer. In a case of containing other layers, polymer (d1) with a core-shell structure is a polymer obtained by graft polymerizing plural kinds of polymers to a polymer to be a core layer to form a multilayered polymer.

The core layer is not particularly limited, and may be a rubber layer. Examples of the rubber layer include a (meth)acrylic rubber layer, a silicone rubber layer, a styrene rubber layer, a conjugated diene rubber layer, an α-olefin rubber layer, a nitrile rubber layer, a urethane rubber layer, a polyester rubber layer, a polyamide rubber layer, and a copolymer rubber layer of two or more of these rubbers. Among them, the rubber layer is preferably a (meth)acrylic rubber layer, a silicone rubber layer, a styrene rubber layer, a conjugated diene rubber layer, an α-olefin rubber layer, and a copolymer rubber layer of two or more of these rubbers. The rubber layer may be a rubber layer obtained by copolymerizing and crosslinking a crosslinking agent (divinyl benzene, allyl acrylate, butylene glycol diacrylate, and the like).

As examples of (meth)acrylic rubber, a polymer rubber obtained by polymerizing a (meth)acrylic component (an alkyl ester of (meth)acrylic acid having 2 to 8 carbon atoms and the like) may be mentioned.

Examples of the silicone rubber include rubber made of a silicone component (polydimethyl siloxane, polyphenyl siloxane, and the like).

Examples of the styrene rubber include a polymer rubber obtained by polymerizing a styrene component (styrene, α-methyl styrene, and the like).

Examples of the conjugated diene rubber include a polymer rubber obtained by polymerizing a conjugated diene component (butadiene, isoprene, and the like).

Examples of the α-olefin rubber include a polymer rubber obtained by polymerizing an α-olefin component (ethylene, propylene, and 2-methylpropylene).

Examples of the copolymer rubber include a copolymer rubber obtained by polymerizing two or more kinds of (meth) acrylic components, a copolymer rubber obtained by polymerizing a (meth) acrylic component and a silicone component, a copolymer rubber obtained by polymerizing a (meth) acrylic component, a conjugated diene component, and a styrene component.

In the polymer constituting the shell layer, examples of alkyl (meth)acrylate include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate. In the alkyl (meth)acrylate, at least a part of hydrogen of an alkyl chain may be substituted. Examples of the substituent include an amino group, a hydroxy group, and a halogeno group.

Among them, from the viewpoint of easily obtaining a resin molded article with high chemical resistance by adding component (B), as a polymer of alkyl (meth)acrylate, a polymer of alkyl (meth)acrylate having an alkyl chain with 1 to 8 carbon atoms is preferable, a polymer of alkyl (meth)acrylate having an alkyl chain with 1 or 2 carbon atoms is more preferable, and a polymer of alkyl (meth)acrylate having an alkyl chain with 1 carbon atom still is more preferable.

The polymer constituting the shell layer may be a polymer obtained by polymerizing at least one selected from a glycidyl group-containing vinyl compound and unsaturated dicarboxylic anhydride in addition to the alkyl (meth)acrylate.

Examples of the glycidyl group-containing vinyl compound include glycidyl (meth) acrylate, glycidyl itaconate, diglycidyl itaconate, allyl glycidyl ether, styrene-4-glycidyl ether, and 4-glycidyl styrene.

Examples of the unsaturated dicarboxylic anhydride include maleic anhydride, itaconic anhydride, glutaconic anhydride, citraconic anhydride, and aconitic anhydride. Among them, maleic anhydride is preferable.

In a case where other layers are provided between the core layer and the shell layer, examples of the other layers include a polymer layer described for the shell layer.

A weight ratio of the shell layer is preferably from 1% by weight to 40% by weight, is more preferably from 3% by weight to 30% by weight, and is still more preferably from 5% by weight to 15% by weight, with respect to the entire core-shell structure.

An average primary particle diameter of a polymer having a core-shell structure is not particularly limited, and from the viewpoint of easily obtaining the effect of improving the toughness by adding component (B), it is preferably from 50 nm to 500 nm, is more preferably from 50 nm to 400 nm, is still more preferably from 100 nm to 300 nm, and is particularly preferably from 150 nm to 250 nm. The average primary particle diameter means a value measured by the following method.

The average primary particle diameter is a number average primary particle diameter which is an average of primary particle diameters over 100 particles. Each of the primary particle diameters is the maximum diameter in each primary particle and measured by observing the particles with a scanning electron microscope. Specifically, the average primary particle diameter is obtained by observing a dispersed form of the polymer having a core-shell structure in the resin composition with a scanning electron microscope.

Polymer (d1) having a core-shell structure may be prepared by a known method.

As a known method, an emulsion polymerization method may be mentioned. Specifically, the following methods are exemplified as a preparing method. First, a core particle (core layer) is prepared by emulsion polymerization of a mixture of monomers, and then a mixture of other monomers is subjected to emulsion polymerization in the presence of the core particle (core layer) to form a polymer having a core-shell structure in which a shell layer is formed around the core particle (core layer). In a case of forming other layers between the core layer and the shell layer, the emulsion polymerization of a mixture of other monomers is repeated to obtain a polymer having a core-shell structure composed of a target core layer, other layers, and a shell layer.

Examples of the commercially available product of the polymer (d1) with core-shell structure include “METABLEN” (registered trademark) prepared by Mitsubishi Chemical Corporation, “KANE ACE” (registered trademark) prepared by Kaneka Corporation, “PARALOID” (registered trademark) prepared by Dow Chemical Japan Limited, “STAPHYLOID” (registered trademark) prepared by Aica Kogyo Company, Limited, and “PARAFACE” (registered trademark) prepared by KURARAY Co., Ltd.

(Polymer (d2) with a Core-Shell Structure: Component (d2))

Polymer (d2) with a core-shell structure is a polymer with a core-shell structure having a core layer and a shell layer on the surface of the core layer.

Polymer (d2) with a core-shell structure is a polymer having a core layer as an innermost layer and a shell layer as an outermost layer (specifically, a polymer obtained by graft polymerizing a styrene polymer or an acrylonitrile-styrene polymer to a core layer containing a butadiene polymer so as to form a shell layer).

One or more other layers (for example, 1 to 6 other layers) may be provided between the core layer and the shell layer. In a case where one or more other layers are provided between the core layer and the shell layer, polymer (d2) with a core-shell structure is a polymer obtained by graft polymerizing plural kinds of polymers to a polymer to be a core layer to form a multilayered polymer.

The core layer containing a butadiene polymer is not particularly limited as long as it is a polymer obtained by polymerizing a component containing butadiene, and may be a core layer of a homopolymer of butadiene or may be a core layer of a copolymer of butadiene and other monomers. In a case where the core layer is a copolymer of butadiene and other monomers, examples of other monomers include vinyl aromatics. Among the vinyl aromatics, a styrene component (for example, styrene, alkyl-substituted styrene (for example, α-methyl styrene, 2-methyl styrene, 3-methyl styrene, 4-methyl styrene, 2-ethyl styrene, 3-ethyl styrene, and 4-ethyl styrene), and halogen-substituted styrene (for example, 2-chlorostyrene, 3-chlorostyrene, and 4-chlorostyrene)) may be used. The styrene component may be used alone or two or more kinds thereof may be used in combination. Among the styrene components, styrene is preferably used. As other monomers, multifunctional monomers such as allyl (meth) acrylate, triallyl isocyanurate, and divinyl benzene may be used.

Specifically, the core layer containing a butadiene polymer may be, for example, a homopolymer of butadiene, and may be a copolymer of butadiene and styrene, or it may be a terpolymer of butadiene, styrene and divinylbenzene.

In the butadiene polymer contained in the core layer, a ratio of a constitutional unit derived from butadiene is preferably from 60% by weight to 100% by weight (preferably from 70% by weight to 100% by weight), and a ratio of a constitutional unit derived from the other monomers (preferably styrene component) is preferably from 0% by weight to 40% by weight (preferably from 0% by weight to 30% by weight). For example, as a ratio of a constitutional unit derived from each monomer constituting the butadiene polymer, butadiene is from 60% by weight to 100% by weight, styrene is from 0% by weight to 40% by weight, and the content of divinyl benzene may be from 0% to 5% by weight with respect to the total amount of styrene and divinylbenzene.

The shell layer containing a styrene polymer is not particularly limited as long as the shell layer contains a polymer obtained by polymerizing a styrene component, and may be a shell layer of a homopolymer of styrene or a copolymer of styrene and other monomers. Examples of the styrene component include the same components as the styrene component exemplified for the core layer. Examples of other monomers include alkyl (meth)acrylate (for example, methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate). In the alkyl (meth)acrylate, at least a part of hydrogen of an alkyl chain may be substituted. Examples of the substituent include an amino group, a hydroxy group, and a halogeno group. The alkyl (meth)acrylate may be used alone or two or more kinds thereof may be used in combination. As other monomers, multifunctional monomers such as allyl (meth) acrylate, triallyl isocyanurate, and divinyl benzene may be used.

The styrene polymer contained in the shell layer may be a copolymer of a styrene component of from 85% by weight to 100% by weight and other monomer components (preferably alkyl (meth)acrylate) of from 0% by weight to 15% by weight.

Among them, from the viewpoint of easily obtaining a resin composition with high chemical resistance by adding component (B), the styrene polymer contained in the shell layer is preferably a copolymer of styrene and alkyl (meth)acrylate. From the same viewpoint, a copolymer of styrene and alkyl (meth)acrylate having an alkyl chain with 1 to 8 carbon atoms is preferable, and a polymer of alkyl (meth)acrylate having an alkyl chain with 1 to 4 carbon atoms is more preferable.

The shell layer containing an acrylonitrile-styrene polymer is a shell layer containing a copolymer of an acrylonitrile component and a styrene component. The acrylonitrile-styrene polymer is not particularly limited, and examples thereof include known acrylonitrile-styrene polymers. Examples of the acrylonitrile-styrene polymer include a copolymer of an acrylonitrile component of from 10% by weight to 80% by weight and a styrene component of from 20% by weight to 90% by weight. Examples of the styrene component copolymerized with the acrylonitrile component include the same components as the styrene component exemplified for the core layer. As the acrylonitrile-styrene polymer contained in the shell layer, multifunctional monomers such as allyl (meth) acrylate, triallyl isocyanurate, and divinyl benzene may be used.

In a case where other layers are provided between the core layer and the shell layer, examples of the other layers include a polymer layer described for the shell layer.

A weight ratio of the shell layer is preferably from 1% by weight to 40% by weight, is more preferably from 3% by weight to 30% by weight, and is still more preferably from 5% by weight to 15% by weight, with respect to the entire core-shell structure.

Among components (d2), examples of the commercially available product of polymer (d2) with a core-shell structure having a core layer containing a butadiene polymer, and a shell layer containing a styrene polymer on the surface of the core layer include “METABLEN” (registered trademark) prepared by Mitsubishi Chemical Corporation, “KANE ACE” (registered trademark) prepared by Kaneka Corporation, “Clearstrength” (registered trademark) prepared by Arkema, and “PARALOID” (registered trademark) prepared by Dow Chemical Japan Limited. Among components (d2), examples of the commercially available product of polymer (d2) with core-shell structure having a core layer containing a butadiene polymer, and a shell layer containing an acrylonitrile-styrene polymer on the surface of the core layer include “blendex” (registered trademark) prepared by Galata Chemicals, and “ELIX” prepared by ELIX POLYMERS.

An average primary particle diameter of polymer (d1) having a core-shell structure and polymer (d2) having a core-shell structure is not particularly limited, and from the viewpoint of the chemical resistance of the resin molded article to be obtained, it is preferably from 50 nm to 500 nm, is more preferably from 50 nm to 400 nm, is still more preferably from 100 nm to 300 nm, and is particularly preferably from 150 nm to 250 nm.

The average primary particle diameter means a value measured by the following method. The average primary particle diameter is a number average primary particle diameter which is an average of primary particle diameter over 100 particles. Each of the primary particle diameters is the maximum diameter in each primary particle and measured by observing the particles with a scanning electron microscope. Specifically, the average primary particle diameter is obtained by observing a dispersed form of the polymer having a core-shell structure in the resin composition with a scanning electron microscope.

(Olefin Polymer (d3): Component (d3))

Olefin polymer (d3) is a polymer of α-olefin and alkyl (meth)acrylate, and is preferably an olefin polymer containing 60% by weight or more of a constitutional unit derived from α-olefin.

In the olefin polymer, examples of the α-olefin include ethylene, propylene, and 2-methyl propylene. From the viewpoint of the chemical resistance of the obtained resin molded article, α-olefin having 2 to 8 carbon atoms is preferable, and α-olefin having 2 or 3 carbon atoms is more preferable. Among them, ethylene is still more preferable.

Examples of the alkyl (meth)acrylate polymerized with α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate. From the viewpoint of the chemical resistance of the obtained resin molded article, alkyl (meth)acrylate having an alkyl chain with 1 to 8 carbon atoms is preferable, alkyl (meth)acrylate having an alkyl chain with 1 to 4 carbon atoms is more preferable, and alkyl (meth)acrylate having an alkyl chain with 1 or 2 carbon atom still is more preferable.

From the viewpoint of the chemical resistance of the obtained resin molded article, the olefin polymer is preferably a polymer of ethylene and methyl acrylate.

From the viewpoint of the chemical resistance of the obtained resin molded article, in the olefin polymer, the constitutional unit derived from α-olefin is preferably from 60% by weight to 97% by weight and is more preferably from 70% by weight to 85% by weight.

The olefin polymer may have other constitutional units in addition to the constitutional unit derived from α-olefin and the constitutional unit derived from alkyl (meth)acrylate. Here, other constitutional units may be 10% by weight or less with respect to the entire constitutional units in the olefin polymer.

(Styrene-Ethylene-Butadiene-Styrene Copolymer (d4): Component (d4))

The copolymer (d4) is not particularly limited as long as it is a thermoplastic elastomer, and examples thereof include a known styrene-ethylene-butadiene-styrene copolymer. The copolymer (d4) may be a styrene-ethylene-butadiene-styrene copolymer and a hydrogenated product thereof.

From the viewpoint of the chemical resistance of the obtained resin molded article, copolymer (d4) is preferably a hydrogenated product of the styrene-ethylene-butadiene-styrene copolymer. From the same viewpoint, copolymer (d4) may be a block copolymer, for example, it is preferably a copolymer (triblock copolymer of styrene-ethylene/butylene-styrene) having a block of a styrene moiety at both ends and a block of a moiety containing a central ethylene/butylene by hydrogenating at least a part of a double bond of a butadiene moiety. The ethylene/butylene block moiety of the styrene-ethylene/butylene-styrene copolymer may be a random copolymer.

Copolymer (d4) is obtained by a known method. In a case where copolymer (d4) is the hydrogenated product of the styrene-ethylene-butadiene-styrene copolymer, for example, the copolymer is obtained by hydrogenating the butadiene moiety of a styrene-butadiene-styrene block copolymer in which the conjugated diene moiety is composed of 1,4 bonds.

Examples of the commercially available product of copolymer (d4) include “Kraton” (registered trademark) prepared by Kraton Corporation, and “Septon” (registered trademark) prepared by KURARAY Co., Ltd.

(Polyurethane (d5): Component (d5))

Polyurethane (d5) is not particularly limited as long as it is a thermoplastic elastomer, and examples thereof include known polyurethane. Polyurethane (d5) is preferably linear polyurethane. Polyurethane (d5) may be obtained, for example, by reacting a polyol component (polyether polyol, polyester polyol, polycarbonate polyol, or the like), an organic isocyanate component (aromatic diisocyanate, aliphatic (including alicyclic) diisocyanate, or the like), and if necessary, a chain extender (aliphatic (including alicyclic) diol, or the like). The polyol component may be used alone, or two or more kinds thereof may be used in combination and the organic isocyanate component may be used alone, or two or more kinds thereof may be used in combination.

From the viewpoint of the chemical resistance of the obtained resin molded article, polyurethane (d5) is preferably aliphatic polyurethane. As aliphatic polyurethane, for example, aliphatic polyurethane obtained by reacting a polyol component containing polycarbonate polyol and an isocyanate component containing aliphatic diisocyanate is preferable.

Polyurethane (d5) may be obtained by reacting the polyol component and the organic isocyanate component so that a value of NCO/OH ratio in a raw material in the synthesis of polyurethane is in a range of 0.90 to 1.5, for example. Polyurethane (d5) is obtained by a known method such as a one shot method and a prepolymerization method.

Examples of the commercially available product of polyurethane (d5) include “Estane” (registered trademark) prepared by Lubrizol, and “Elastollan” (registered trademark) prepared by BASF. “Desmopan” (registered trademark) prepared by Bayer is exemplified.

(Polyester (d6): Component (d6))

Polyester (d6) is not particularly limited as long as it is a thermoplastic elastomer, and examples thereof include known polyester. From the viewpoint of the chemical resistance of the obtained resin molded article, polyester (d6) is preferably aromatic polyester. In the exemplary embodiment, aromatic polyester represents polyester having an aromatic ring in its structure.

Examples of polyester (d6) include a polyester copolymer (polyether ester, polyester ester, or the like). Specific examples thereof include a polyester copolymer having a hard segment composed of a polyester unit and a soft segment composed of a polyester unit; a polyester copolymer having a hard segment composed of a polyester unit and a soft segment composed of a polyether unit; and a polyester copolymer having a hard segment composed of a polyester unit and a soft segment composed of a polyether unit and a polyester unit. A weight ratio of the hard segment of the polyester copolymer to the soft segment of the polyester copolymer (hard segment/soft segment) may be, for example, from 20/80 to 80/20. The polyester unit constituting the hard segment and the polyester unit and polyether unit constituting the soft segment may be either aromatic or aliphatic (including alicyclic).

The polyester copolymer as polyester (d6) is obtained by using a known method. The polyester copolymer is preferably a linear polyester copolymer. The polyester copolymer is obtained by, for example, a method of esterifying or transesterifying a dicarboxylic acid component having 4 to 20 carbon atoms, a diol component having 2 to 20 carbon atoms, and a polyalkylene glycol component having the number average molecular weight of 300 to 20000 (including an alkylene oxide adduct of polyalkylene glycol), and a method of esterifying or transesterifying these components to prepare an oligomer and then polycondensating this oligomer. In addition, for example, a method of esterifying or transesterifying a dicarboxylic acid component having 4 to 20 carbon atoms, a diol component having 2 to 20 carbon atoms, and an aliphatic polyester component having the number average molecular weight of 300 to 20000 maybe exemplified. The dicarboxylic acid component is an aromatic or aliphatic dicarboxylic acid, or an ester derivative thereof, the diol component is aromatic or aliphatic diol, and the polyalkylene glycol component is aromatic or aliphatic polyalkylene glycol.

Among them, from the viewpoint of the chemical resistance of the obtained resin molded article, the dicarboxylic acid component of the polyester copolymer preferably uses a dicarboxylic acid component having an aromatic ring. Each of the diol component and polyalkylene glycol component preferably uses an aliphatic diol component and an aliphatic polyalkylene glycol component.

Examples of the commercially available product of polyester (d6) include “PELPRENE” (registered trademark) prepared by Toyobo Co., Ltd., “HYTREL” (registered trademark) prepared by Du Pont-Toray Co., Ltd.

Thermoplastic elastomer (D) may be used alone, or two or more kinds thereof may be used in combination.

[Content or Content Ratio of Each of the Above Components]

The resin composition according to the exemplary embodiment contains a resin having a biomass-derived carbon atom (component (A) or the like), and, if necessary, contains component (B), component (C), and component (D), and other components (E) described below. From the viewpoint of the chemical resistance of the obtained resin molded article, the content or content ratio of each component of the resin composition according to the exemplary embodiment is preferably in the following range (all are on a mass basis).

The abbreviation of each component is as follows.

Component (A)=Cellulose acylate (A)

Component (B)=Ester compound (B)

Component (C)=Plasticizer (C)

Component (D)=Thermoplastic elastomer (D)

A content of a resin having a biomass-derived carbon atom in the resin composition according to the exemplary embodiment is preferably 50% by weight or more, is more preferably 60% by weight or more, and is still more preferably 70% by weight or more, with respect to the entire mass of the resin composition.

A content of component (A) in the resin composition according to the exemplary embodiment is preferably 50% by weight or more, is more preferably 60% by weight or more, and is still more preferably 70% by weight or more, with respect to the entire mass of the resin composition. In addition, the content of the component (A) in the resin composition according to the exemplary embodiment is preferably 50 parts by mass or more, is more preferably 80 parts by mass or more, and is still more preferably from 95 parts by mass to 100 parts by mass, with respect to 100 parts by mass of a content of the resin having a biomass-derived carbon atom.

A content of component (B) in the resin composition according to the exemplary embodiment is preferably from 0.1% by weight to 15% by weight, is more preferably from 0.5% by weight to 10% by weight, and is still more preferably from 1% by weight to 5% by weight, with respect to the entire mass of the resin composition.

A content of component (C) in the resin composition according to the exemplary embodiment is preferably from 0.01% by weight to 5% by weight, is more preferably from 1% by weight to 25% by weight, is still more preferably from 3% by weight to 20% by weight, and is most preferably from 5% by weight to 15% by weight, with respect to the entire mass of the resin composition.

A content of component (D) in the resin composition according to the exemplary embodiment is preferably from 1% by weight to 20% by weight, is more preferably from 3% by weight to 15% by weight, and is still more preferably from 5% by weight to 10% by weight, with respect to the entire mass of the resin composition.

A content ratio of component (B) to resin (A^{Bio}) having a biomass-derived carbon atom is preferably 0.0025≤(B/A^{Bio})≤0.1, is more preferably 0.003≤(B/A^{Bio})≤0.095, and is still more preferably 0.005≤(B/A^{Bio})≤0.05.

In addition, a content ratio of component (B) to component (A) is preferably 0.0025≤(B/A)≤0.1, is more preferably 0.003≤(B/A)≤0.095, and is still more preferably 0.005≤(B/A)≤0.05.

A content ratio of component (C) to resin (A^{Bio}) having a biomass-derived carbon atom is preferably 0.03≤(C/A^{Bio})≤0.3, is more preferably 0.05≤(C/A^{Bio})≤0.2, and is still more preferably 0.07≤(C/A^{Bio})≤0.15.

Further, a content ratio of component (C) to component (A) is preferably 0.05≤(C/A)≤0.3, is more preferably 0.05≤(C/A)≤0.2, and is still more preferably 0.07≤(C/A)≤0.3.

A content ratio of component (D) to resin (A^{Bio}) having a biomass-derived carbon atom is preferably 0.025≤(D/A^{Bio})≤0.3, is more preferably 0.05≤(D/A^{Bio})≤0.2, and is still more preferably 0.07≤(D/A^{Bio})≤0.1.

In addition, a content ratio of component (D) to component (A) is preferably 0.025≤(D/A)≤0.3, is more preferably 0.05≤(D/A)≤0.2, and is still more preferably 0.07≤(D/A)≤0.1.

[Other Components (E)]

The resin composition according to the exemplary embodiment may contain other components (E) (component (E)). In a case of containing other components (E), a total content of other components (E) is preferably 15% by weight or less, and is more preferably 10% by weight or less, with respect to the entire content of the resin composition.

Examples of other components (E) include flame retardant, a compatibilizer, an oxidation inhibitor, a stabilizer, a release agent, a light stabilizer, a weathering agent, a colorant, a pigment, a modifier, a drip inhibitor, an antistatic agent, a hydrolysis inhibitor, a filler, a reinforcing agent (for example, glass fiber, carbon fiber, talc, clay, mica, glass flake, milled glass, glass beads, crystalline silica, alumina, silicon nitride, aluminum nitride, and boron nitride), an acid acceptor to prevent acetic acid release (for example, oxides such as magnesium oxide and aluminum oxide; metal hydroxide such as magnesium hydroxide, calcium hydroxide, aluminum hydroxide, and hydrotalcite; calcium carbonate; and talc), a reactive trapping agent (for example, an epoxy compound, an acid anhydride compound, and carbodiimide).

The content of each of other components (E) is preferably from 0% by weight to 5% by weight with respect to the entire amount of the resin composition. Here, “0% by weight” means not containing other components (E).

In addition to the resin having a biomass-derived carbon atom (component (A) or the like), component (B), component (C), and component (D), the resin composition according to the exemplary embodiment may contain other resins as other components (E). However, in a case of containing other resins, a content of other resins is preferably 5% by weight or less and is more preferably less than 1% by weight, with respect to the total amount of the resin composition. It is particularly preferably not to contain other resins in the resin composition (that is, 0% by weight).

Examples of other resins include thermoplastic resins in the related art, and specific examples thereof include a polycarbonate resin; a polypropylene resin; a polyester resin; a polyolefin resin; a polyester carbonate resin; a polyphenylene ether resin; a polyphenylene sulfide resin; a polysulfone resin; a polyether sulfone resin; a polyarylene resin; a polyetherimide resin; a polyacetal resin; a polyvinyl acetal resin; a polyketone resin; a polyether ketone resin; a polyetheretherketone resin; a polyaryl ketone resin; a polyether nitrile resin; a liquid crystal resin; a polybenzimidazole resin; a polyparabanic acid resin; a vinyl polymer or copolymer obtained by polymerization or copolymerization of one or more vinyl monomers selected from the group consisting of aromatic alkenyl compounds, methacrylic acid esters, acrylic acid esters, and vinyl cyanide compounds; a diene-aromatic alkenyl compound copolymer; a vinyl cyanide-diene-aromatic alkenyl compound copolymer; an aromatic alkenyl compound-diene-vinyl cyanide-N-phenyl maleimide copolymer; a vinyl cyanide-(ethylene-diene-propylene (EPDM))-aromatic alkenyl compound copolymer; a vinyl chloride resin; and a chlorinated vinyl chloride resin.

These resins may be used alone or two or more kinds thereof may be used in combination.

The polyester as other components (E) may contain aliphatic polyester (e2). Examples of aliphatic polyester (e1) include a polymer of hydroxyalkanoate (hydroxyalkanoic acid), a polycondensate of polyvalent carboxylic acid and polyhydric alcohol, a ring-opening polycondensate of cyclic lactam, and a polymer obtained by polymerization of lactic acid by ester bond.

Further, the resin composition according to the exemplary embodiment preferably contains an oxidation inhibitor or a stabilizer as other components (E). The oxidation inhibitor or the stabilizer preferably contains at least one compound (e3) selected from the group consisting of a hindered phenol compound, a tocopherol compound, a tocotrienol compound, a phosphite compound and a hydroxylamine compound.

Compound (e3) may be used alone or two or more kinds thereof may be used in combination, but from the viewpoint of a steel ball drop impact strength of the obtained resin molded article, it is preferable to use two or more kinds in combination. A form in which two or more kinds thereof are used in combination may be any one of a form in which two or more kinds thereof are used in combination in the same group (for example, two or more kinds of hindered phenol compounds), and a form in which two or more kinds thereof are used in combination with other groups (for example, a hindered phenol compound and a tocopherol compound).

From the viewpoint of the steel ball drop impact strength of the obtained resin molded article, the form in which two or more kinds thereof are used in combination is preferably a form in which at least one selected from the group consisting of a hindered phenol compound and a hydroxylamine compound and a phosphite compound are used in combination, and is more preferably a form in which a hindered phenol compound and a phosphite compound are used in combination.

A content of compound (e3) in the resin composition according to the exemplary embodiment is preferably from 0.01% by weight to 5% by weight, is more preferably from 0.05% by weight to 2% by weight, and is still more preferably from 0.1% by weight to 1% by weight, with respect to the entire mass of the resin composition.

Specific examples of compound (e3) include a hindered phenol compound such as “Irganox 1010”, “Irganox 245”, and “Irganox 1076”, which are prepared by BASF, “ADK STAB AO-80”, “ADK STAB AO-60”, “ADK STAB AO-50”, “ADK STAB AO-40”, “ADK STAB AO-30”, “ADK STAB AO-20”, and “ADK STAB AO-330”, which are prepared by ADEKA CORPORATION, and “Sumilizer GA-80”, “Sumilizer GM”, and “Sumilizer GS” which are prepared by Sumitomo Chemical Company, Limited; a phosphite compound such as “Irgafos 38” (bis(2,4-di-t-butyl-6-methyl phenyl)-ethyl-phosphite), “Irgafos 168”, “Irgafos TNPP”, and “Irgafos P-EPQ”, which are prepared by BASF; and a hydroxylamine compound such as “Irgastab FS-042” prepared by BASF.

Further, specific examples of the tocopherol compound in compound (e3) include the following compounds.

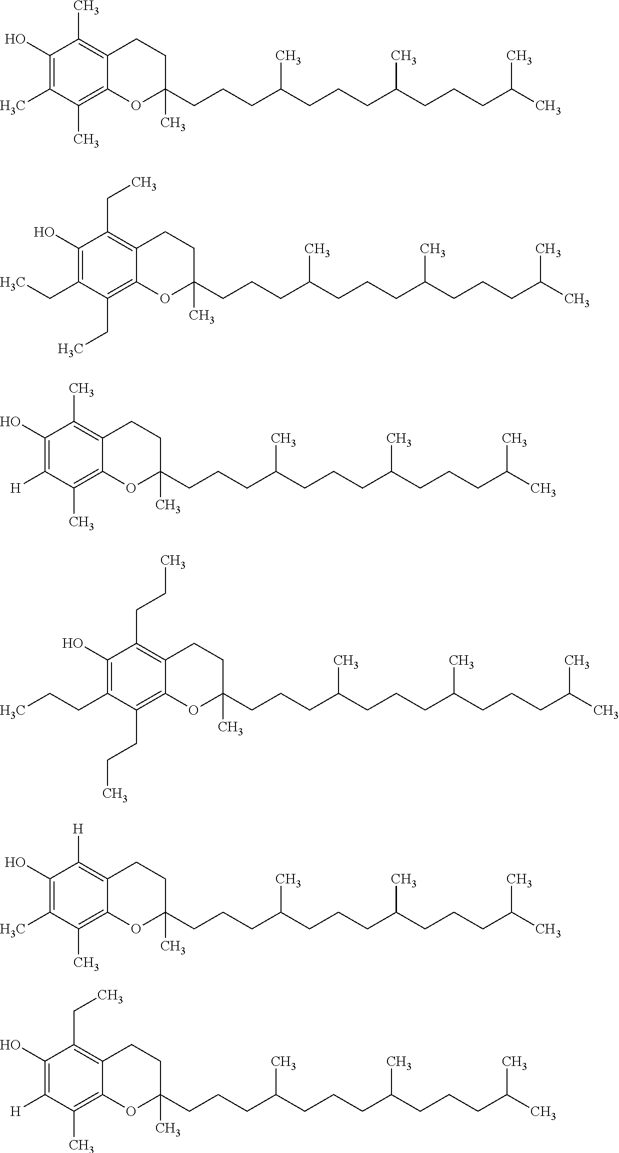

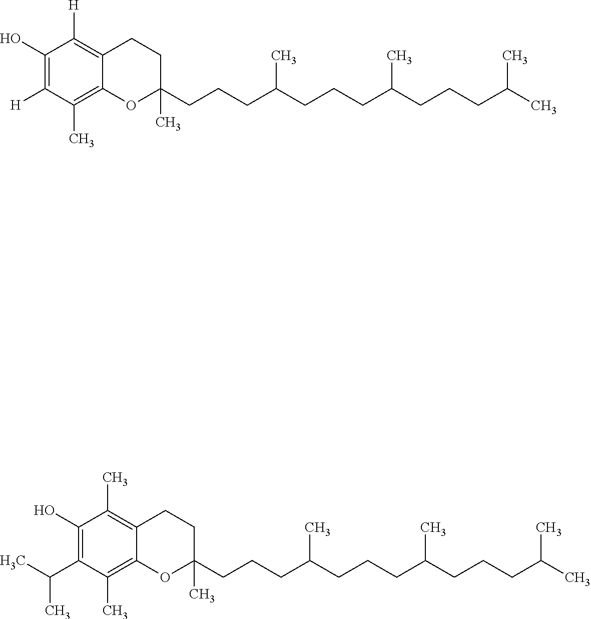

Specific examples of the tocotrienol compound in compound (e3) include the following compounds.

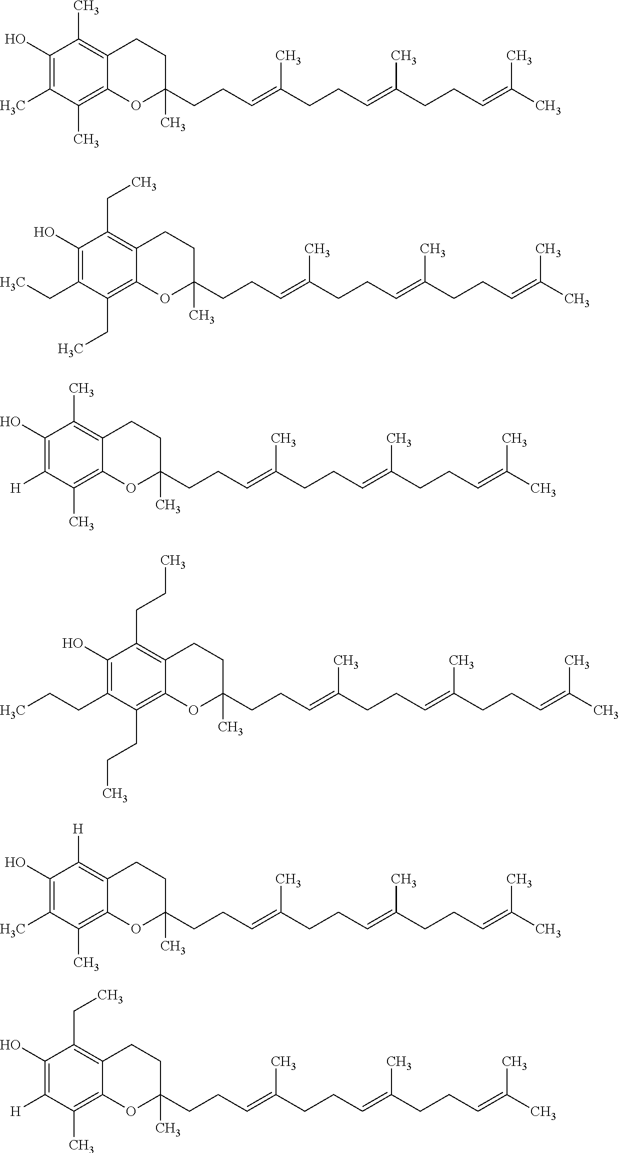

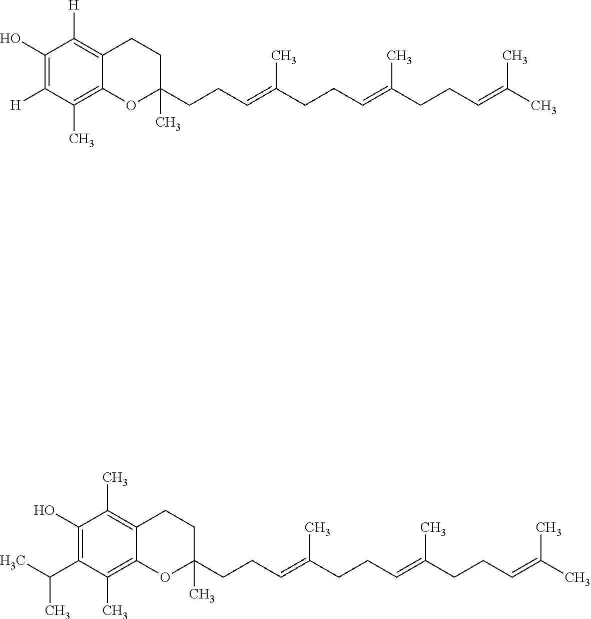

[Method of Preparing a Resin Composition]

Examples of the method of preparing the resin composition according to the exemplary embodiment include a method of mixing and melt-kneading a resin having a biomass-derived carbon atom (component (A) or the like), and, if necessary, component (B), component (C), component (D), and other components (E); and a method of dissolving a resin having a biomass-derived carbon atom (component (A) or the like), and, if necessary, component (B), component (C), component (D), and other components (E) in a solvent. Means for melt-kneading is not particularly limited, and examples thereof include a twin-screw extruder, a HENSCHEL MIXER, a BANBURY MIXER, a single screw extruder, a multi-screw extruder, and a co-kneader.

<Resin Molded Article>

The resin molded article according to the exemplary embodiment contains a resin composition according to the exemplary embodiment. That is, the resin molded article according to the exemplary embodiment has the same composition as that of the resin composition according to the exemplary embodiment.

From the viewpoint of high degree of freedom of shape, injection molding is preferable as the method of molding the resin molded article according to the exemplary embodiment. Therefore, from the viewpoint of high degree of freedom of shape, the resin molded article according to the exemplary embodiment is preferably an injection molded article obtained by injection molding.

A cylinder temperature at the time of injection molding of the resin molded article according to the exemplary embodiment is preferably, for example, from 160° C. to 280° C., and is more preferably from 180° C. to 240° C. A mold temperature at the time of injection molding of the resin molded article according to the exemplary embodiment is preferably, for example, from 40° C. to 90° C., and is more preferably from 40° C. to 60° C.

The injection molding of the resin molded article according to the exemplary embodiment may be performed by using a commercially available apparatus such as NEX500 Nissei Plastic Industrial Co., Ltd., NEX150 Nissei Plastic Industrial Co., Ltd., NEX7000 manufactured by Nissei Plastic Industrial Co., Ltd., PNX40 manufactured by Nissei Plastic Industrial Co., Ltd., and SE50D manufactured by Sumitomo Heavy Industries, Ltd.

The molding method for obtaining the resin molded article according to the exemplary embodiment is not limited to the above-described injection molding, and for example, extrusion molding, blow molding, hot press molding, calender molding, coating molding, cast molding, dipping molding, vacuum molding, transfer molding and the like may be applied.

The resin molded article according to the exemplary embodiment is suitably used for applications such as electronic and electrical equipment, office equipment, household electric appliances, automotive interior materials, toys, and containers. Specific applications of the resin molded product according to the exemplary embodiment include a housing of electronic and electrical equipment or a household electrical appliance; various parts of an electronic and electrical equipment or a home electric appliance; an interior component of a car; a block assembly toy; a plastic model kit; storage case of CD-ROM or DVD; dishware; beverage bottle; food tray; wrapping material; film; and sheet.

### EXAMPLES

The resin composition according to the exemplary embodiment and resin molded article will be further specifically described with reference to the following examples.

Materials, amounts, ratios, processing procedures, and the like described in the following examples may be appropriately changed without departing from the gist of the exemplary embodiment. Therefore, the resin composition and the resin molded article according to the exemplary embodiment are not to be interpreted restrictively by the following specific examples.

<Preparation of each material>

The following materials are prepared.

[Resin Having a Biomass-Derived Carbon Atom]

—Cellulose Acylate (A)—
CA1: “CAP482-20” prepared by Eastman Chemical Company, cellulose acetate propionate, weight average degree of polymerization: 716, degree of acetyl group substitution: 0.18, degree of propionyl group substitution: 2.49
CA2: “CAP482-0.5” prepared by Eastman Chemical Company, cellulose acetate propionate, weight average degree of polymerization: 189, degree of acetyl group substitution: 0.18, degree of propionyl group substitution: 2.49
CA3: “CAP504-0.2” prepared by Eastman Chemical Company, cellulose acetate propionate, weight average degree of polymerization: 133, degree of acetyl group substitution: 2.09, degree of propionyl group substitution: 0.04
CA4: “CAB171-15” prepared by Eastman Chemical Company, cellulose acetate butyrate, weight average degree of polymerization: 754, degree of acetyl group substitution:

2.07, degree of butyryl group substitution: 0.73
CA7: “L50” prepared by Daicel Corporation., diacetyl cellulose, weight average degree of polymerization: 570
CA8 “LT-35” prepared by Daicel Corporation., triacetyl cellulose, weight average degree of polymerization: 385
RC1: “Tenite propionate 360A4000012” prepared by Eastman Chemical Company, cellulose acetate propionate, weight average degree of polymerization: 716, degree of acetyl group substitution: 0.18, degree of propionyl group substitution: 2.49

The above products contains dioctyl adipate corresponding to component (C). Cellulose acetate propionate in the above product is 88% by weight and dioctyl adipate contained in the above product is 12% by weight.
RC2: “Treva GC6021” prepared by Eastman Chemical Company, cellulose acetate propionate, weight average degree of polymerization: 716, degree of acetyl group substitution: 0.18, degree of propionyl group substitution: 2.49

The above product contains chemical substances corresponding to component (D).

CA1 satisfied the following (2), (3), and (4). CA2 satisfied the following (4). (2) When measurement is performed by a GPC method with tetrahydrofuran as a solvent, a weight average molecular weight (Mw) in terms of polystyrene is 160000 to 250000, a ratio

Mn/Mz of number average molecular weight (Mn) in terms of polystyrene to Z-average molecular weight (Mz) in terms of polystyrene is from 0.14 to 0.21, and a ratio Mw/Mz of weight average molecular weight (Mw) in terms of polystyrene to Z-average molecular weight (Mz) in terms of polystyrene is from 0.3 to 0.7. (3) When measurement is performed with capillograph at 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is from 0.1 to 0.3. (4) When a small square plate test piece (D11 test piece specified by JIS K7139:2009, 60 mm×60 mm, thickness of 1 mm) obtained by injection molding of CAP is left for 48 hours in an atmosphere at a temperature of 65° C. and a relative humidity of 85%, both the expansion coefficient in a MD direction and the expansion coefficient in a TD direction are 0.4% to 0.6%.

—Resin Having a Biomass-Derived Carbon Atom Other than Cellulose Acylate (A)—
PE1: “Ingeo3001D” prepared by Nature Works LLC, polylactic acid
PE2: “Braskem SGF4950” prepared by Braskem S.A, bio-derived polyethylene
PM: “RILSAN” prepared by Arkema S.A, polyamide 11 (polyamide obtained by ring-opening polycondensation of undecane lactam)
PH1: “Biopole” prepared by Monsanto Company, poly(3-hydroxybutyric acid)

[Ester Compound (B)]
LU1: “STEARYL STEARATE” prepared by FUJIFILM Wako Pure Chemical Corporation, stearyl stearate

Compound represented by Formula (1), the number of carbon atoms of R^{H}: 17, the number of carbon atoms R¹²: 18
LU2: “ETHYLENE GLYCOL DISTEARATE” prepared by FUJIFILM Wako Pure Chemical Corporation, ethylene glycol distearate

Compound represented by Formula (2), the number of carbon atoms of R²¹: 17, the number of carbon atoms of R²²: 17
LU3: “GLYCERYL DISTEARATE” prepared by FUJIFILM Wako Pure Chemical Corporation, glyceryl distearate

Compound represented by Formula (3), the number of carbon atoms of R³¹: 17, the number of carbon atoms of R³²: 17
LU4: prepared by Tokyo Chemical Industry Co., Ltd. “Decyl Decanoate”, decyl decanoate

Compound represented by Formula (1), the number of carbon atoms of R^{H}: 9, the number of carbon atoms of R¹²: 10
LU5: “LAURYL LAURATE” prepared by Larodan Fine Chemicals, dodecyl dodecanoate

Compound represented by Formula (1), the number of carbon atoms of R¹¹: 11, the number of carbon atoms of R¹²: 12
LU6: “DOCOSYL DOCOSANOATE” prepared by FUJIFILM Wako Pure Chemical Corporation, docosyl docosanoate

Compound represented by Formula (1), the number of carbon atoms of R^{H}: 21, the number of carbon atoms of R¹²: 22

[Plasticizer (C)]
PL1: “NX-2026” prepared by Cardolite, cardanol, molecular weight: 298 to 305
PL4: “Ultra LITE 513” prepared by Cardolite, glycidyl ether of cardanol, molecular weight: 354 to 361
PL6: “Daifatty 101” prepared by Daihachi Chemical Industry Co., Ltd., adipic acid ester-containing compound, molecular weight: 326 to 378
PL7: “DOA” prepared by Mitsubishi Chemical Corporation, dioctyl adipate, molecular weight of 371

[Thermoplastic Elastomer (D)]
EL1: “METABLEN W-600A” prepared by Mitsubishi Chemical Corporation, polymer (d2) with a core-shell structure, polymer in which a shell layer is obtained by graft polymerizing a “methyl methacrylate homopolymer rubber” to a “homocopolymer rubber of 2-ethyl hexyl acrylate and n-butyl acrylate” corresponding to a core layer, average primary particle diameter of 200 nm
EL5: “Kane Ace B-564” prepared by KANEKA CORPORATION, methyl methacrylate-butadiene-styrene copolymerization (MBS) resin, polymer (d1) with core-shell structure
EL6: “Blendex 338” prepared by Galata Chemicals (Artek), acrylonitrile-butadiene-styrene copolymer (ABS) core-shell, polymer (d1) with core-shell structure
EL7: “Kraton FG1924G” prepared by Kraton Corporation, styrene-ethylene-butadiene-styrene copolymer (SEBS) (d4)
EL8: “Estane ALR 72A” prepared by Lubrizol, polyurethane (d5)
EL9: “Hytrel 3078” prepared by Du Pont-Toray Co., Ltd., aromatic polyester copolymer, polyester (d6)

[Other Components (E)]
PM1: “DELPET 720V” Asahi Kasei Corporation., polymethyl methacrylate
ST1: “Irganox B225” prepared by BASF, a mixture of tetrakis [3-(3′,5′-di-t-butyl-4′-hydroxyphenyl) propionic acid] pentaerythritol and tris(2,4-di-t-butylphenyl) phosphite
ST2: “Epoxidized octyl tallate” prepared by Eastman Chemical Company, epoxidized octyl tallate

—Metal Particles—
ME1: “ATMEL 300 M” manufactured by Kobe Steel Ltd., iron particles, volume average particle diameter of 70
ME2: “ULTRAFINE NICKEL” manufactured by Toho Titanium Co., Ltd., nickel particles, volume average particle diameter of 400 nm
ME3: “CHROME POWDER-45 μm, 99.5%” manufactured by FUJIFILM Wako Pure Chemical Corporation, chromium particles, volume average particle diameter of 45 μm or less
ME4: “IRON POWDER-45 μm, 99.5%” manufactured by FUJIFILM Wako Pure Chemical Corporation, iron particles, volume average particle diameter of 45 μm or less
ME5: “NICKEL POWDER-150 μm” manufactured by FUJIFILM Wako Pure Chemical Corporation, nickel particles, volume average particle diameter of 150 μm or less
ME6: “METALLIC CHROME 200 mesh” manufactured by Jean Tech Co., Ltd., chromium particles, volume average particle diameter of 75 μm or less
ME7: “IRON OXIDE” manufactured by JFE Chemical Co., iron oxide particles (70% iron)
ME8: “NICKEL ACETATE” manufactured by Nihon Kagaku Sangyo Co., Ltd., nickel acetate particles (nickel 23% by weight)
ME9: “TAIKA CHROME 100” manufactured by Nippon Chemical Industrial Co., Ltd., chromium phosphate particles (chromium 15% by weight)

### <Preparation of Resin Composition and Injection Molding of Resin Molded Article (Preparation of ISO Multipurpose Dumbbell Test Piece and D2 Test Piece)> [Examples 1 to 44, and Comparative Examples 1 to 8]

Kneading is carried out with a twin-screw kneader (TEX 41SS, manufactured by Toshiba Machine Co., Ltd.) at a content ratio of each component and a kneading temperature indicated in Tables 1 to 4 so as to obtain a resin composition in a pellet shape.

With the obtained pelletized resin composition, an ISO multipurpose dumbbell test piece (corresponding to ISO 527 tensile test, ISO 178 bending test, test part thickness of 4 mm, width of 10 mm) is molded at molding temperature and mold temperature indicated in Table 2 or 4 without exceeding 180 MPa of the injection peak pressure by using an injection molding machine (NEX 500 manufactured by Nissei Plastic Industrial Co., Ltd.).

In accordance with the method defined in ISO 294-3:2002, with the obtained resin composition in the pellet shape, a D2 test piece (60 mm×60 mm x thickness of 2 mm) is molded under the condition of an injection peak pressure not exceeding 180 MPa and a molding temperature and a mold temperature indicated in Table 2 or 4 by using an injection molding machine (NEX 5001, manufactured by Nissei Plastic Industrial Co., Ltd.).

<Measurement of Content of Biomass-Derived Carbon Atom>

With the obtained resin composition in the pellet shape, the abundance of ¹⁴C in the entire carbon atoms in the resin composition is measured based on the regulation of ASTM D 6866:2012, and the content of biomass-derived carbon atom is calculated.

Measurement results are indicated in Table 2 or 4.

<Measurement of Metal Content>

The contents of the iron element, the nickel element, and the chromium element of the obtained resin composition in pellet shape are measured by using a high-resolution ICP emission spectroscopic analyzer (PS 3500 DDII manufactured by Hitachi High-Tech Sciences Co., Ltd.).

Measurement results are indicated in Table 2 or 4.

<Evaluation of Chemical Resistance>

The obtained ISO multipurpose dumbbell test piece is fixed with a bending strain of 1% using a jig, the following chemicals are applied to the whole test piece surface, and left to stand at 23° C. for 96 hours to visually observe the occurrence of cracks and craze, and the presence or absence of breakage.

Hand cream 1 (MINTVERBENA SOLVE CREAM, manufactured by L′ Occitane)

Hand cream 2 (ATRIX, manufactured by Kao Corporation)

Sunscreen 1 (UV LOTION SPF 50+PA+++, manufactured by Kao Corporation)

Sunscreen 2 (SK-II ATMOSPHERE AIRY LIGHT SPF 50+PA++++, manufactured by P & D Prestige)

In the order of hand cream 1, hand cream 2, sunscreen 1, sunscreen 2, the chemicals described later have more influence on resin molded bodies. Evaluation criteria for chemical resistance are shown below.

A: Neither crazes nor cracks have been seen

B: Craze has occurred, but cracks have not occurred

C: Crack has occurred

<Measurement of Puncture Impact Strength (Maximum Impact Force)>

With respect to the obtained D2 test piece, maximum impact force (N) of the puncture impact test is measured under the conditions of a striker mass of 5 kg, a falling height of 0.66 m, and a test piece thickness of 2 mm according to ISO 6003:2000. The larger the value of the maximum impact force, the more excellent the puncture impact strength.

Evaluation results are indicated in Table 2 or 4.

TABLE 1

| | Resin having biomass-derived carbon atom | | | | | | | | | | | |
|---|---|---|---|---|---|---|---|---|---|---|---|---|
| | | | | | Resins other than | | | | | | | |
| | Cellulose acylate | | | | cellulose acylate | | | | Ester compound | | Plasticizer | |
| | (A) | | | | (A) | | Other resins | | (B) | | (C) | |
| | Kinds | Content | Kinds | Content | Kinds | Content | Kinds | Content | Kinds | Content | Kinds | Content |
| Example 1 | CA1 | 91.5 | — | — | — | — | — | — | — | — | PL1 | 8.5 |
| Example 2 | CA1 | 91.5 | — | — | PE1 | 5 | PM1 | 5 | LU1 | 2 | PL1 | 8.5 |
| Example 3 | RC2 | 100 | — | — | — | — | — | — | — | — | PL1 | 5 |
| Example 4 | RC1 | 100 | — | — | — | — | PM1 | 15 | — | — | — | — |
| Example 5 | CA1 | 70 | — | — | PE2 | 30 | — | — | — | — | — | — |
| Example 6 | CA1 | 70 | — | — | PA1 | 30 | — | — | — | — | — | — |
| Example 7 | CA3 | 91.5 | — | — | — | — | — | — | — | — | PL1 | 8.5 |
| Example 8 | CA4 | 91.5 | — | — | — | — | — | — | — | — | PL1 | 8.5 |
| Example 9 | CA7 | 85 | — | — | — | — | — | — | — | — | PL1 | 15 |
| Example 10 | CA8 | 75 | — | — | — | — | — | — | — | — | PL1 | 25 |
| Example 11 | — | — | — | — | PE1 | 100 | — | — | — | — | PL1 | 15 |
| Example 12 | — | — | — | — | PH1 | 50 | PM1 | 50 | — | — | PL1 | 8.5 |
| Example 13 | — | — | — | — | PE2 | 50 | PM1 | 50 | — | — | PL1 | 8.5 |
| Example 14 | CA1 | 91.5 | — | — | — | — | — | — | — | — | PL2 | 8.5 |
| Example 15 | CA1 | 91.5 | — | — | — | — | — | — | — | — | PL6 | 8.5 |
| Example 16 | CA1 | 91.5 | — | — | — | — | — | — | — | — | PL1 | 8.5 |
| Example 17 | CA1 | 91.5 | — | — | — | — | — | — | — | — | PL1 | 8.5 |
| Example 18 | CA1 | 91.5 | — | — | — | — | — | — | — | — | PL1 | 8.5 |
| Example 19 | CA1 | 91.5 | — | — | — | — | — | — | — | — | PL1 | 8.5 |
| Example 20 | CA1 | 91.5 | — | — | — | — | — | — | — | — | PL1 | 8.5 |
| Example 21 | CA1 | 91.5 | — | — | — | — | — | — | — | — | PL1 | 8.5 |
| Comparative | CA1 | 91.5 | — | — | — | — | — | — | — | — | PL1 | 8.5 |
| Example 1 | | | | | | | | | | | | |
| Comparative | CA1 | 91.5 | — | — | — | — | — | — | — | — | PL1 | 8.5 |
| Example 2 | | | | | | | | | | | | |
| Comparative | CA1 | 47.5 | CA2 | 47.5 | — | — | — | — | — | — | — | — |
| Example 3 | | | | | | | | | | | | |
| Comparative | — | — | — | — | PE1 | 85 | — | — | — | — | PL6 | 17 |
| Example 4 | | | | | | | | | | | | |
| Comparative | CA1 | 88 | — | — | — | — | — | — | — | — | PL7 | 12 |
| Example 5 | | | | | | | | | | | | |
| Comparative | — | — | — | — | PH1 | 50 | PM1 | 50 | — | — | PL1 | 8.5 |
| Example 6 | | | | | | | | | | | | |
| Comparative | — | — | — | — | PE2 | 50 | PM1 | 50 | — | — | PL1 | 8.5 |
| Example 7 | | | | | | | | | | | | |

| | Thermoplastic elastomer | | Other components | | | | | | | |
|---|---|---|---|---|---|---|---|---|---|---|
| | (D) | | (E) | | Metal powder (ppm) | | | | | |
| | Kinds | Content | Kinds | Content | Kinds | Content | Kinds | Content | Kinds | Content |
| Example 1 | EL1 | 7.5 | ST1 | 0.5 | ME1 | 2.5 | ME2 | 1.0 | ME3 | 1.5 |
| Example 2 | EL1 | 7.5 | ST1 | 0.5 | ME1 | 2.5 | ME2 | 1.0 | ME3 | 1.5 |
| Example 3 | — | — | ST1 | 0.5 | ME1 | 2.5 | ME2 | 1.0 | ME3 | 1.5 |
| Example 4 | EL1 | 5 | ST1 | 0.5 | ME1 | 2.5 | ME2 | 1.0 | ME3 | 1.5 |
| Example 5 | — | — | — | — | ME1 | 2.5 | ME2 | 1.0 | ME3 | 1.5 |
| Example 6 | — | — | — | — | ME1 | 2.5 | ME2 | 1.0 | ME3 | 1.5 |
| Example 7 | EL1 | 7.5 | ST1 | 0.5 | ME1 | 2.5 | ME2 | 1.0 | ME3 | 1.5 |
| Example 8 | EL1 | 7.5 | ST1 | 0.5 | ME1 | 2.5 | ME2 | 1.0 | ME3 | 1.5 |
| Example 9 | EL1 | 7.5 | ST1 | 0.5 | ME1 | 2.5 | ME2 | 1.0 | ME3 | 1.5 |
| Example 10 | EL1 | 7.5 | ST1 | 0.5 | ME1 | 2.5 | ME2 | 1.0 | ME3 | 1.5 |
| Example 11 | EL1 | 15 | — | — | ME1 | 2.5 | ME2 | 1.0 | ME3 | 1.5 |
| Example 12 | EL1 | 7.5 | — | — | ME1 | 2.5 | ME2 | 1.0 | ME3 | 1.5 |
| Example 13 | EL1 | 7.5 | — | — | ME1 | 2.5 | ME2 | 1.0 | ME3 | 1.5 |
| Example 14 | EL1 | 7.5 | ST1 | 0.5 | ME1 | 2.5 | ME2 | 1.0 | ME3 | 1.5 |
| Example 15 | EL1 | 7.5 | ST1 | 0.5 | ME1 | 2.5 | ME2 | 1.0 | ME3 | 1.5 |
| Example 16 | EL6 | 7.5 | ST1 | 0.5 | ME1 | 2.5 | ME2 | 1.0 | ME3 | 1.5 |
| Example 17 | EL7 | 7.5 | ST1 | 0.5 | ME1 | 2.5 | ME2 | 1.0 | ME3 | 1.5 |
| Example 18 | EL8 | 7.5 | ST1 | 0.5 | ME1 | 2.5 | ME2 | 1.0 | ME3 | 1.5 |
| Example 19 | EL9 | 7.5 | ST1 | 0.5 | ME1 | 2.5 | ME2 | 1.0 | ME3 | 1.5 |
| Example 20 | EL1 | 7.5 | ST1 | 0.5 | ME1 | 0.17 | ME2 | 0.04 | ME3 | 0.04 |
| Example 21 | EL1 | 7.5 | ST1 | 0.5 | ME1 | 4.5 | ME2 | 1.5 | ME3 | 2.5 |
| Comparative | EL1 | 7.5 | ST1 | 0.5 | ME1 | 0.08 | ME2 | 0.04 | ME3 | 0.04 |
| Example 1 | | | | | | | | | | |
| Comparative | EL1 | 7.5 | ST1 | 0.5 | ME1 | 5.2 | ME2 | 2.2 | ME3 | 3.2 |
| Example 2 | | | | | | | | | | |
| Comparative | EL5 | 4 | ST2 | 1 | — | — | — | — | — | — |
| Example 3 | | | | | | | | | | |
| Comparative | EL1 | 7.5 | — | — | — | — | — | — | — | — |
| Example 4 | | | | | | | | | | |
| Comparative | — | — | — | — | — | — | — | — | — | — |
| Example 5 | | | | | | | | | | |
| Comparative | EL1 | 7.5 | — | — | — | — | — | — | — | — |
| Example 6 | | | | | | | | | | |
| Comparative | EL1 | 7.5 | — | — | — | — | — | — | — | — |
| Example 7 | | | | | | | | | | |

TABLE 2

| | | | | Content of | Content | Content |
|---|---|---|---|---|---|---|
| | Kneading | Molding | Mold | biomass-derived | of iron | of nickel |
| | temperature | temperature | temperature | carbon atom | element | element |
| | (° C.) | (° C.) | (° C.) | (%) by weight | (ppm) | (ppm) |
| Example 1 | 200 | 200 | 40 | 48 | 2.7 | 1.2 |
| Example 2 | 200 | 200 | 40 | 48 | 2.7 | 1.2 |
| Example 3 | 230 | 230 | 40 | 45 | 2.6 | 1.4 |
| Example 4 | 200 | 200 | 40 | 31 | 2.7 | 1.2 |
| Example 5 | 200 | 200 | 40 | 60 | 2.5 | 1.1 |
| Example 6 | 220 | 220 | 40 | 60 | 2.7 | 1.2 |
| Example 7 | 200 | 200 | 40 | 48 | 2.7 | 1.1 |
| Example 8 | 200 | 200 | 40 | 49 | 2.8 | 1.2 |
| Example 9 | 220 | 220 | 40 | 54 | 2.9 | 1.3 |
| Example 10 | 230 | 230 | 40 | 53 | 2.7 | 1.2 |
| Example 11 | 170 | 170 | 60 | 86 | 2.7 | 1.1 |
| Example 12 | 160 | 160 | 60 | 48 | 2.4 | 1.2 |
| Example 13 | 180 | 180 | 40 | 48 | 2.7 | 1.3 |
| Example 14 | 200 | 200 | 40 | 45 | 2.7 | 1.2 |
| Example 15 | 200 | 200 | 40 | 36 | 2.8 | 1.1 |
| Example 16 | 200 | 200 | 40 | 48 | 2.7 | 1.2 |
| Example 17 | 200 | 200 | 40 | 48 | 3.1 | 1.4 |
| Example 18 | 200 | 200 | 40 | 48 | 2.7 | 1.2 |
| Example 19 | 200 | 200 | 40 | 48 | 2.5 | 1.2 |
| Example 20 | 200 | 200 | 40 | 48 | 0.2 | 0.05 |
| Example 21 | 200 | 200 | 40 | 48 | 4.8 | 1.7 |
| Comparative | 200 | 200 | 40 | 48 | 0.05 | 0.03 |
| Example 1 | | | | | | |
| Comparative | 200 | 200 | 40 | 48 | 5.5 | 2.2 |
| Example 2 | | | | | | |
| Comparative | 230 | 230 | 40 | 40 | 0 | 0 |
| Example 3 | | | | | | |
| Comparative | 180 | 180 | 60 | 90 | 0 | 0 |
| Example 4 | | | | | | |
| Comparative | 200 | 200 | 40 | 39 | 0 | 0 |
| Example 5 | | | | | | |
| Comparative | 160 | 160 | 60 | 48 | 0 | 0 |
| Example 6 | | | | | | |
| Comparative | 180 | 180 | 40 | 48 | 0 | 0 |
| Example 7 | | | | | | |

| | Content | | | | | |
|---|---|---|---|---|---|---|
| | of chromium | Chemical resistance | | | | Maximum |
| | element | Hand | Hand | | | impact |
| | (ppm) | cream 1 | cream 2 | Sunscreen 1 | Sunscreen 2 | force (N) |
| Example 1 | 1.8 | A | A | A | A | 3600 |
| Example 2 | 2.0 | A | A | A | A | 2450 |
| Example 3 | 1.8 | A | A | A | A | 2400 |
| Example 4 | 1.9 | A | A | A | A | 1650 |
| Example 5 | 1.8 | A | A | A | A | 1750 |
| Example 6 | 1.7 | A | A | A | A | 1650 |
| Example 7 | 1.8 | A | A | A | A | 3500 |
| Example 8 | 2.1 | A | A | A | A | 3600 |
| Example 9 | 1.8 | A | A | A | B | 1650 |
| Example 10 | 2.2 | A | A | A | B | 1350 |
| Example 11 | 1.8 | A | A | A | B | 1350 |
| Example 12 | 1.9 | A | A | A | B | 1550 |
| Example 13 | 1.7 | A | A | A | B | 1850 |
| Example 14 | 1.8 | A | A | A | A | 3600 |
| Example 15 | 1.6 | A | A | A | A | 3800 |
| Example 16 | 1.8 | A | A | A | A | 3300 |
| Example 17 | 2.2 | A | A | A | A | 3300 |
| Example 18 | 1.8 | A | A | A | A | 3200 |
| Example 19 | 1.8 | A | A | A | A | 3300 |
| Example 20 | 0.05 | A | A | B | B | 1900 |
| Example 21 | 2.8 | A | A | B | B | 2050 |
| Comparative | 0.03 | B | B | C | C | 1050 |
| Example 1 | | | | | | |
| Comparative | 3.3 | B | B | C | C | 1000 |
| Example 2 | | | | | | |
| Comparative | 0 | B | B | C | C | 800 |
| Example 3 | | | | | | |
| Comparative | 0 | C | C | C | C | 650 |
| Example 4 | | | | | | |
| Comparative | 0 | B | B | C | C | 800 |
| Example 5 | | | | | | |
| Comparative | 0 | C | C | C | C | 800 |
| Example 6 | | | | | | |
| Comparative | 0 | B | B | C | C | 750 |
| Example 7 | | | | | | |

TABLE 2

| | Resin having biomass-derived carbon atom | | | | | | | | | |
|---|---|---|---|---|---|---|---|---|---|---|
| | | | Resins other than | | | | | | | |
| | Cellulose acylate | | cellulose acylate | | Other | | Ester compound | | Plasticizer | |
| | (A) | | (A) | | resins | | (B) | | (C) | |
| | Kinds | Content | Kinds | Content | Kinds | Content | Kinds | Content | Kinds | Content |
| Example 22 | CA1 | 91.5 | — | — | — | — | LU2 | 2 | PL1 | 8.5 |
| Example 23 | CA1 | 91.5 | — | — | — | — | LU3 | 2 | PL1 | 8.5 |
| Example 24 | CA1 | 91.5 | — | — | — | — | LU4 | 2 | PL1 | 8.5 |
| Example 25 | CA1 | 91.5 | — | — | — | — | LU5 | 2 | PL1 | 8.5 |
| Example 26 | CA1 | 91.5 | — | — | — | — | LU6 | 2 | PL1 | 8.5 |
| Example 27 | CA1 | 91.5 | — | — | — | — | LU1 | 0.3 | PL1 | 8.5 |
| Example 28 | CA1 | 91.5 | — | — | — | — | LU1 | 8 | PL1 | 8.5 |
| Example 29 | CA1 | 91.5 | — | — | — | — | LU1 | 0.2 | PL1 | 8.5 |
| Example 30 | CA1 | 91.5 | — | — | — | — | LU1 | 12 | PL1 | 8.5 |
| Example 31 | CA1 | 91.5 | — | — | — | — | LU1 | 2 | PL1 | 8.5 |
| Example 32 | CA1 | 91.5 | — | — | — | — | LU1 | 2 | PL1 | 8.5 |
| Example 33 | CA1 | 91.5 | — | — | — | — | LU1 | 2 | PL1 | 8.5 |
| Example 34 | CA1 | 91.5 | — | — | — | — | LU1 | 2 | PL1 | 8.5 |
| Example 35 | CA1 | 91.5 | — | — | — | — | LU1 | 2 | PL1 | 8.5 |
| Example 36 | CA1 | 91.5 | — | — | — | — | LU1 | 2 | PL1 | 8.5 |
| Example 37 | CA1 | 91.5 | — | — | — | — | LU1 | 2 | PL1 | 8.5 |
| Example 38 | CA1 | 91.5 | — | — | — | — | LU1 | 2 | PL1 | 8.5 |
| Example 39 | CA1 | 91.5 | — | — | — | — | LU1 | 2 | PL1 | 8.5 |
| Example 40 | CA1 | 91.5 | — | — | — | — | LU1 | 2 | PL1 | 8.5 |
| Example 41 | CA1 | 91.5 | — | — | — | — | LU1 | 2 | PL1 | 8.5 |
| Example 42 | CA1 | 91.5 | — | — | — | — | LU1 | 2 | PL1 | 8.5 |
| Example 43 | CA1 | 91.5 | — | — | — | — | LU1 | 2 | PL1 | 8.5 |
| Example 44 | CA1 | 77 | — | — | — | — | LU1 | 2 | PL6 | 8.5 |
| Comparative | — | — | — | — | PM1 | 100 | — | — | PL6 | 10 |
| Example 8 | | | | | | | | | | |

| | Thermoplastic elastomer | | Other components | | | | | | | |
|---|---|---|---|---|---|---|---|---|---|---|
| | (D) | | (E) | | Metal powder (ppm) | | | | | |
| | Kinds | Content | Kinds | Content | Kinds | Content | Kinds | Content | Kinds | Content |
| Example 22 | EL1 | 7.5 | ST1 | 0.5 | ME1 | 2.5 | ME2 | 1.0 | ME3 | 1.5 |
| Example 23 | EL1 | 7.5 | ST1 | 0.5 | ME1 | 2.5 | ME2 | 1.0 | ME3 | 1.5 |
| Example 24 | EL1 | 7.5 | ST1 | 0.5 | ME1 | 2.5 | ME2 | 1.0 | ME3 | 1.5 |
| Example 25 | EL1 | 7.5 | ST1 | 0.5 | ME1 | 2.5 | ME2 | 1.0 | ME3 | 1.5 |
| Example 26 | EL1 | 7.5 | ST1 | 0.5 | ME1 | 2.5 | ME2 | 1.0 | ME3 | 1.5 |
| Example 27 | EL1 | 7.5 | ST1 | 0.5 | ME1 | 2.5 | ME2 | 1.0 | ME3 | 1.5 |
| Example 28 | EL1 | 7.5 | ST1 | 0.5 | ME1 | 2.5 | ME2 | 1.0 | ME3 | 1.5 |
| Example 29 | EL1 | 7.5 | ST1 | 0.5 | ME1 | 2.5 | ME2 | 1.0 | ME3 | 1.5 |
| Example 30 | EL1 | 7.5 | ST1 | 0.5 | ME1 | 2.5 | ME2 | 1.0 | ME3 | 1.5 |
| Example 31 | EL1 | 7.5 | ST1 | 0.5 | ME4 | 2.5 | ME2 | 1.0 | ME3 | 1.5 |
| Example 32 | EL1 | 7.5 | ST1 | 0.5 | ME1 | 2.5 | ME5 | 1.0 | ME3 | 1.5 |
| Example 33 | EL1 | 7.5 | ST1 | 0.5 | ME1 | 2.5 | ME2 | 1.0 | ME6 | 1.5 |
| Example 34 | EL1 | 7.5 | ST1 | 0.5 | ME1 | 2.5 | ME2 | 1.0 | — | 0 |
| Example 35 | EL1 | 7.5 | ST1 | 0.5 | ME1 | 2.5 | — | 0 | ME3 | 1.5 |
| Example 36 | EL1 | 7.5 | ST1 | 0.5 | — | 0 | ME2 | 1.0 | ME3 | 1.5 |
| Example 37 | EL1 | 7.5 | ST1 | 0.5 | ME1 | 2.5 | — | 0 | — | 0 |
| Example 38 | EL1 | 7.5 | ST1 | 0.5 | — | 0 | ME2 | 1.0 | — | 0 |
| Example 39 | EL1 | 7.5 | ST1 | 0.5 | — | 0 | — | 0 | ME3 | 1.5 |
| Example 40 | EL1 | 7.5 | ST1 | 0.5 | ME7 | 3 | ME2 | 1.0 | ME3 | 1.5 |
| Example 41 | EL1 | 7.5 | ST1 | 0.5 | ME1 | 2.5 | ME8 | 4.0 | ME3 | 1.5 |
| Example 42 | EL1 | 7.5 | ST1 | 0.5 | ME1 | 2.5 | ME2 | 1.0 | ME9 | 9.5 |
| Example 43 | EL1 | 7.5 | ST1 | 0.5 | ME7 | 3 | ME8 | 4.0 | ME9 | 9.5 |
| Example 44 | EL1 | 7.5 | ST1 | 0.5 | ME1 | 2.5 | ME2 | 1.0 | ME3 | 1.5 |
| Comparative | EL1 | 10 | ST1 | 0.5 | ME1 | 2.5 | ME2 | 1.0 | ME3 | 1.5 |
| Example 8 | | | | | | | | | | |

TABLE 4

| | | | | Content of | Content | Content |
|---|---|---|---|---|---|---|
| | Kneading | Molding | Mold | biomass-derived | of iron | of nickel |
| | temperature | temperature | temperature | carbon atom | element | element |
| | (° C.) | (° C.) | (° C.) | (%) by weight | (ppm) | (ppm) |
| Example 22 | 200 | 200 | 40 | 48 | 2.7 | 1.2 |
| Example 23 | 200 | 200 | 40 | 48 | 2.7 | 1.2 |
| Example 24 | 200 | 200 | 40 | 48 | 2.7 | 1.2 |
| Example 25 | 200 | 200 | 40 | 48 | 2.7 | 1.2 |
| Example 26 | 200 | 200 | 40 | 48 | 2.7 | 1.2 |
| Example 27 | 200 | 200 | 40 | 49 | 2.7 | 1.2 |
| Example 28 | 200 | 200 | 40 | 46 | 2.7 | 1.2 |
| Example 29 | 200 | 200 | 40 | 49 | 2.7 | 1.2 |
| Example 30 | 200 | 200 | 40 | 46 | 2.7 | 1.2 |
| Example 31 | 200 | 200 | 40 | 48 | 2.7 | 1.2 |
| Example 32 | 200 | 200 | 40 | 48 | 2.7 | 1.2 |
| Example 33 | 200 | 200 | 40 | 48 | 2.7 | 1.2 |
| Example 34 | 200 | 200 | 40 | 48 | 2.7 | 1.2 |
| Example 35 | 200 | 200 | 40 | 48 | 2.7 | 0 |
| Example 36 | 200 | 200 | 40 | 48 | 0 | 1.2 |
| Example 37 | 200 | 200 | 40 | 48 | 2.7 | 0 |
| Example 38 | 200 | 200 | 40 | 48 | 0 | 1.2 |
| Example 39 | 200 | 200 | 40 | 48 | 0 | 0 |
| Example 40 | 200 | 200 | 40 | 48 | 2.1 | 0 |
| Example 41 | 200 | 200 | 40 | 48 | 0 | 0.94 |
| Example 42 | 200 | 200 | 40 | 48 | 0 | 0 |
| Example 43 | 200 | 200 | 40 | 48 | 2.1 | 0.94 |
| Example 44 | 200 | 200 | 40 | 28 | 2.7 | 1.2 |
| Comparative | 260 | 260 | 40 | 0 | 2.7 | 1.2 |
| Example 8 | | | | | | |

| | Content | | | | | |
|---|---|---|---|---|---|---|
| | of chromium | Chemical resistance | | | | Maximum |
| | element | Hand | Hand | | | impact |
| | (ppm) | cream 1 | cream 2 | Sunscreen 1 | Sunscreen 2 | force (N) |
| Example 22 | 1.8 | A | A | A | A | 3500 |
| Example 23 | 1.8 | A | A | A | A | 3400 |
| Example 24 | 1.8 | A | A | A | A | 3450 |
| Example 25 | 1.8 | A | A | A | A | 3500 |
| Example 26 | 1.8 | A | A | A | A | 3400 |
| Example 27 | 1.8 | A | A | A | A | 3400 |
| Example 28 | 1.8 | A | A | B | B | 1900 |
| Example 29 | 1.8 | A | A | A | B | 2850 |
| Example 30 | 1.8 | A | A | B | B | 1800 |
| Example 31 | 1.8 | A | A | A | A | 3300 |
| Example 32 | 1.8 | A | A | A | A | 3500 |
| Example 33 | 1.8 | A | A | A | A | 3350 |
| Example 34 | 0 | A | A | A | B | 2850 |
| Example 35 | 1.8 | A | A | A | B | 2750 |
| Example 36 | 1.8 | A | A | A | B | 2800 |
| Example 37 | 0 | A | A | A | B | 1900 |
| Example 38 | 0 | A | A | A | B | 1950 |
| Example 39 | 1.2 | A | A | A | B | 1850 |
| Example 40 | 0 | A | A | A | A | 1900 |
| Example 41 | 0 | A | A | A | A | 1800 |
| Example 42 | 1.4 | A | A | A | A | 1900 |
| Example 43 | 1.4 | A | A | A | A | 3350 |
| Example 44 | 1.8 | A | A | B | B | 1700 |
| Comparative | 1.8 | B | B | C | C | 250 |
| Example 8 | | | | | | |

In Table 1 and Table 3, the unit of the content of metal powder is ppm relative to the whole resin composition, and the unit of the content of each component other than metal powder is part by mass.

From the above results, it is understood that the resin composition of the examples may obtain a resin molded article excellent in the chemical resistance as compared with the resin composition of the comparative example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising a resin having a biomass-derived carbon atom and satisfying at least one of the following conditions (1) to (3),
(1) a content of an iron element in the resin composition is from 0.1 ppm to 5 ppm with respect to the resin composition,
(2) a content of a nickel element in the resin composition is from 0.05 ppm to 2 ppm with respect to the resin composition, and
(3) a content of a chromium element in the resin composition is from 0.05 ppm to 3 ppm with respect to the resin composition.

2. The resin composition according to claim 1,
wherein a content of the biomass-derived carbon atom in the resin composition, which is defined in ASTM D6866:2012, is 30% or more with respect to a total amount of carbon atoms in the resin composition.

3. The resin composition according to claim 1 that satisfies the condition (1).

4. The resin composition according to claim 1 that satisfies the condition (2).

5. The resin composition according to claim 1 that satisfies the condition (3).

6. The resin composition according to claim 1 that satisfies the conditions (1), (2) and (3).

7. The resin composition according to claim 1,
wherein the resin having a biomass-derived carbon atom contains a cellulose acylate (A).

8. The resin composition according to claim 7,
wherein the cellulose acylate (A) is at least one compound selected from the group consisting of a cellulose acetate propionate (CAP) and a cellulose acetate butyrate (CAB).

9. The resin composition according to claim 1,
wherein a content of the cellulose acylate (A) is 50% by weight or more with respect to the resin composition.

10. The resin composition according to claim 1, further comprising at least one ester compound (B) selected from the group consisting of a compound represented by Formula (1), a compound represented by Formula (2), a compound represented by Formula (3), a compound represented by Formula (4), and a compound represented by Formula (5), 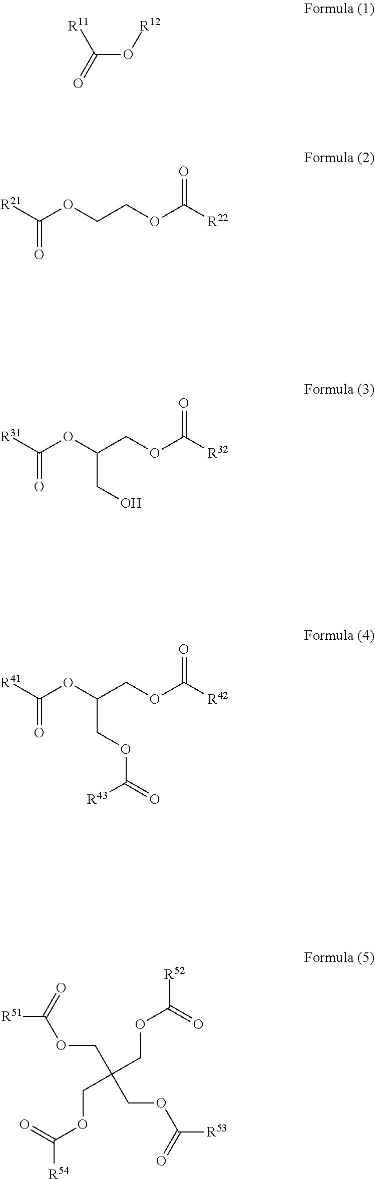
wherein R¹¹ represents an aliphatic hydrocarbon group having 7 to 28 carbon atoms and R¹² represents an aliphatic hydrocarbon group having 9 to 28 carbon atoms,
R²¹ and R²² each independently represent an aliphatic hydrocarbon group having 7 to 28 carbon atoms,
R³¹ and R³² each independently represent an aliphatic hydrocarbon group having 7 to 28 carbon atoms,
R⁴¹, R⁴², and R⁴³ each independently represent an aliphatic hydrocarbon group having 7 to 28 carbon atoms, and
R⁵¹, R⁵², R⁵³ and R⁵⁴ each independently represent an aliphatic hydrocarbon group having 7 to 28 carbon atoms.

11. The resin composition according to claim 10,
wherein a weight ratio (B/A^{Bio}) of the at least one ester compound (B) to the resin having a biomass-derived carbon atom (A^{Bio}) is from 0.005 to 0.05.

12. The resin composition according to claim 1, further comprising a plasticizer (C).

13. The resin composition according to claim 12,
wherein the plasticizer (C) contains at least one selected from the group consisting of a cardanol compound, a dicarboxylic acid diester, a citric acid ester, a polyether compound having at least one unsaturated bond in a molecule, a polyetherester compound, a benzoic acid glycol ester, a compound represented by Formula (6), and an epoxidized fatty acid ester, 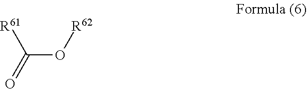
wherein R⁶¹ represents an aliphatic hydrocarbon group having 7 to 28 carbon atoms and R⁶² represents an aliphatic hydrocarbon group having 1 to 8 carbon atoms.

14. The resin composition according to claim 12,
wherein the plasticizer (C) contains a cardanol compound.

15. The resin composition according to claim 1, further comprising a thermoplastic elastomer (D).

16. The resin composition according to claim 15,
wherein the thermoplastic elastomer (D) contains at least one selected from the group consisting of a core-shell structure polymer (d1) having a core layer and a shell layer containing an alkyl (meth)acrylate polymer on a surface of the core layer, and an olefin polymer (d2) that is a polymer of an α-olefin and an alkyl (meth)acrylate and that contains 60% by weight or more of a constituent unit derived from the α-olefin.

17. The resin composition according to claim 1, further comprising particles containing at least one selected from the group consisting of the iron element, the nickel element, and the chromium element.

18. A resin molded article comprising the resin composition according to claim 1.

19. The resin molded article according to claim 18 that is an injection molded article.
